(19) United States
(12) Patent Application Publication
(10) Pub. No.: US 2026/0278292 A1
(43) Pub. Date: Sep. 17, 2026

(54) SYSTEM

(71) Applicant: SoftBank Group Corp., Tokyo (JP)

(72) Inventor: Masayuki ISHIDA, Tokyo (JP)

(73) Assignee: SoftBank Group Corp., Tokyo (JP)

(21) Appl. No.: 19/547,681

(22) Filed: Feb. 24, 2026

Related U.S. Application Data
(60) Provisional application No. 63/769,940, filed on Mar. 11, 2025.

(51) Int. Cl. G06F 40/40; G06F 40/103; G06F 40/253; G06F 40/268; G06F 40/284; G06N 3/0475; G06Q 10/40; G06V 30/19

(52) U.S. Cl. CPC G06F 40/40; G06F 40/103; G06F 40/253; G06F 40/268; G06F 40/284; G06N 3/0475; G06Q 10/40; G06V 30/19

(57) ABSTRACT

A system includes a processor that is configured to acquire post data from a social networking service platform, analyze the acquired post data to detect defamatory content directed to a victim, store detected defamatory messages as evidence, generate documents required for legal procedures based on the stored evidence, and generate and deliver mental care messages to the victim.

### CROSS-REFERENCE TO RELATED APPLICATION

This application claims the benefit of U.S. Provisional Application No. 63/769,940, filed on Mar. 11, 2025, pursuant to 35 U.S.C. § 119 (e), the entire contents of which are incorporated herein by reference.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In recent years, the widespread use of social networking service (SNS) platforms has made it easier for users to communicate and disseminate information, but it has also led to a rapid increase in defamatory content and online harassment directed at specific individuals. Conventional content moderation tools on SNS platforms generally focus on simple keyword filtering or rule-based detection and often fail to accurately capture defamatory expressions that depend on context, sentiment, or nuanced language. As a result, many harmful posts remain undetected or are detected only after significant delay, thereby allowing psychological damage to victims to accumulate.

In addition, victims who suffer from defamatory posts on SNS typically face multiple burdens simultaneously. Victims must collect and preserve evidence of the defamatory content, organize such evidence into a form suitable for legal procedures, and, at the same time, cope with mental distress caused by repeated online attacks. Existing systems generally handle these aspects in a fragmented manner: separate tools may be used for monitoring posts, manually capturing screenshots or logs for evidence, creating legal documents with professional assistance, and independently seeking mental care or counseling services. This fragmentation imposes a heavy workload on victims and can delay effective legal and psychological responses.

Furthermore, conventional systems seldom utilize generative artificial intelligence to provide an integrated solution that performs sophisticated detection of defamatory content, systematic evidence collection and legal document generation, and personalized mental care messaging in a unified workflow. There is a need for a system that can automatically detect defamatory content on SNS with high accuracy using advanced natural language processing and generative AI, collect and structure the relevant evidence for potential legal use, generate legal documents required for legal procedures, and simultaneously provide tailored mental care support to the victim through preferred communication channels.

Accordingly, an object of the invention is to provide a system that accurately detects defamatory content on SNS platforms, systematically collects and organizes evidence with associated metadata, automatically generates documents required for legal procedures, and provides personalized mental care messages to the victim, thereby reducing the burden on the victim and enabling a more prompt and comprehensive response to online defamation and harassment.

### SUMMARY

In order to solve the above problems, the present invention provides a system comprising a processor configured to perform, in an integrated manner, SNS data acquisition, defamatory content detection, evidence collection and legal document generation, and mental care support for a victim.

According to one aspect of the invention, the processor is configured to acquire post data from a social networking service platform and to analyze the acquired post data to detect defamatory content directed to a victim. The processor is further configured to store detected defamatory messages as evidence, to generate documents required for legal procedures based on the stored evidence, and to generate and deliver mental care messages to the victim. By integrating these operations under control of the processor, the system enables continuous monitoring of SNS content, automated detection of defamatory messages, and unified handling of evidence and mental care.

According to another aspect of the invention, the processor is configured to acquire the post data in real time from an application programming interface (API) of the social networking service platform. The processor is configured to analyze content of the acquired post data using natural language processing techniques to detect defamatory content, and to use a pre-trained generative artificial intelligence model to identify posts including offensive wording or negative sentiment and to detect defamatory content directed to a specific person. Through the use of such natural language processing techniques and generative AI, the system can recognize nuanced or context-dependent defamatory expressions that are difficult to detect using simple keyword-based filters, thereby improving detection accuracy and timeliness.

According to still another aspect of the invention, the processor is configured to store the detected defamatory messages in a database and to organize evidence including metadata comprising timestamps and poster identifiers. The processor is configured to generate documents required for the legal procedures based on the organized evidence. In addition, the processor is configured to analyze a psychological state of the victim using a generative artificial intelligence model, to generate a personalized mental care message based on the analyzed psychological state, and to deliver the personalized mental care message to the victim via a communication channel selected according to a preference of the victim. By systematically storing and organizing evidence with relevant metadata, the system can prepare data suitable for use in legal procedures. By generating legal documents automatically from the organized evidence, the system reduces the time and effort required for victims to initiate legal actions. Moreover, by analyzing the victim's psychological state and delivering personalized mental care messages through preferred channels such as email, direct message, or a dedicated application, the system provides continuous psychological support tailored to the victim's needs.

Through these configurations, the system according to the present invention enables comprehensive support for victims of online defamation and harassment on SNS platforms by combining advanced detection of defamatory content, structured evidence management and legal document generation, and personalized mental care provision within a single integrated framework.

The term “social networking service platform” refers to an online service or website that allows users to create accounts, post or share content such as text, images, or videos, interact with other users through features such as comments, likes, or direct messages, and publicly or semi-publicly distribute information over a network.

The term “post data” refers to digital data representing content posted on a social networking service platform, including at least text content and optionally associated information such as images, videos, timestamps, user identifiers, hashtags, and other metadata.

The term “defamatory content” refers to content included in post data that contains insulting, slandering, harassing, or otherwise injurious expressions directed toward a person and that is capable of damaging the reputation, dignity, or social evaluation of that person.

The term “victim” refers to a person or entity that is a target of defamatory content detected by the system and that is intended to receive legal or mental care support provided by the system.

The term “processor” refers to one or more hardware computing devices, such as a central processing unit, a microprocessor, or a combination of processors, configured to execute instructions to perform functions of the system including data acquisition, analysis, evidence storage, document generation, and mental care message generation.

The term “application programming interface” refers to a defined software interface provided by a social networking service platform that specifies how external systems can programmatically request and receive post data and related information from the platform. The term “natural language processing” refers to a set of computational techniques and algorithms that enable a computer system to analyze, interpret, and process human language text, including operations such as tokenization, part-of-speech tagging, sentiment analysis, and context understanding.

The term “generative artificial intelligence model” refers to an artificial intelligence model trained on data to generate or transform content such as text, often using techniques such as neural networks or deep learning, and configured in the system to produce analysis results, legal documents, or mental care messages based on input prompts.

The term “offensive wording” refers to words, phrases, or expressions that are insulting, abusive, degrading, or otherwise inappropriate and that are likely to cause emotional harm or discomfort to the target of the expression.

The term “negative sentiment” refers to an emotional tone of content that expresses unfavorable, hostile, critical, or disparaging attitudes, as determined by sentiment analysis or similar evaluation techniques.

The term “evidence” refers to data collected and stored by the system, including detected defamatory messages and associated metadata, that can be used to support legal procedures or investigations related to online defamation or harassment.

The term “metadata” refers to auxiliary information associated with post data or evidence, including but not limited to timestamps, poster identifiers, platform identifiers, and other contextual information useful for organizing and verifying the evidence.

The term “timestamp” refers to data indicating a time at which an event occurred, such as the time when post data was created on a social networking service platform or when the system stored or processed the post data.

The term “poster identifier” refers to an identifier, such as a user ID, handle, or account name, that uniquely or semi-uniquely identifies a user or account that created or posted content on a social networking service platform.

The term “legal procedures” refers to formal processes or actions undertaken according to laws or regulations, including but not limited to filing complaints, initiating lawsuits, or submitting evidence to law enforcement or judicial authorities in connection with defamation or harassment.

The term “documents required for legal procedures” refers to documents generated by the system based on stored evidence and metadata, including but not limited to complaints, summaries of incidents, evidence lists, and explanatory statements, which are suitable for use in legal procedures.

The term “database” refers to an organized collection of data stored in one or more storage devices under the control of the processor, enabling structured storage, retrieval, updating, and management of post data, evidence, cases, and legal documents.

The term “psychological state of the victim” refers to an estimated or inferred mental condition of the victim, such as emotional distress, anxiety, or need for support, derived from contextual information, usage patterns, or other data analyzed by the system.

The term “mental care message” refers to a message generated by the system, typically using a generative artificial intelligence model, that is intended to provide psychological support, reassurance, guidance, or encouragement to the victim.

The term “personalized mental care message” refers to a mental care message whose content, tone, or structure is adapted based on information related to the victim, such as detected psychological state, preferences, prior interactions, or severity of the detected defamatory content.

The term “communication channel” refers to a medium or path used by the system to deliver messages or information to the victim, including but not limited to email, direct messaging on a social networking service platform, push notifications, or in-application messaging within a dedicated client application.

The term “preference of the victim” refers to configuration information or settings indicating the victim's desired communication methods, frequency, language, or other parameters used by the system when delivering mental care messages or notifications.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

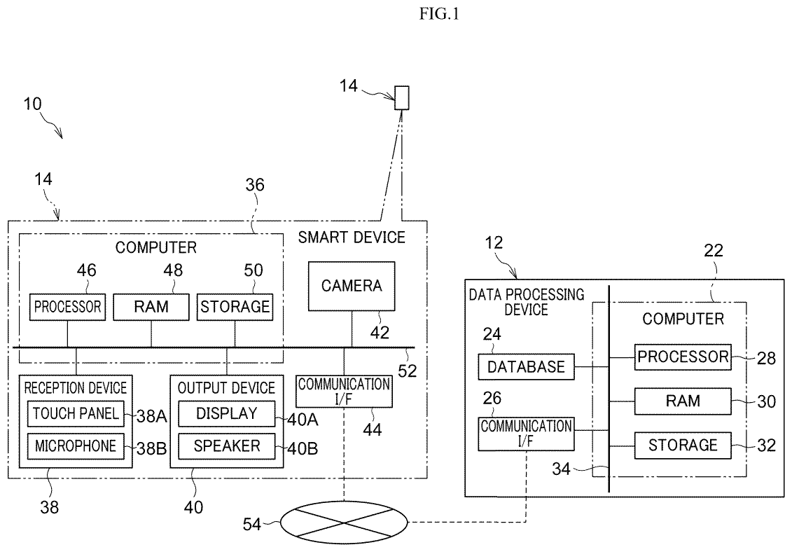

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

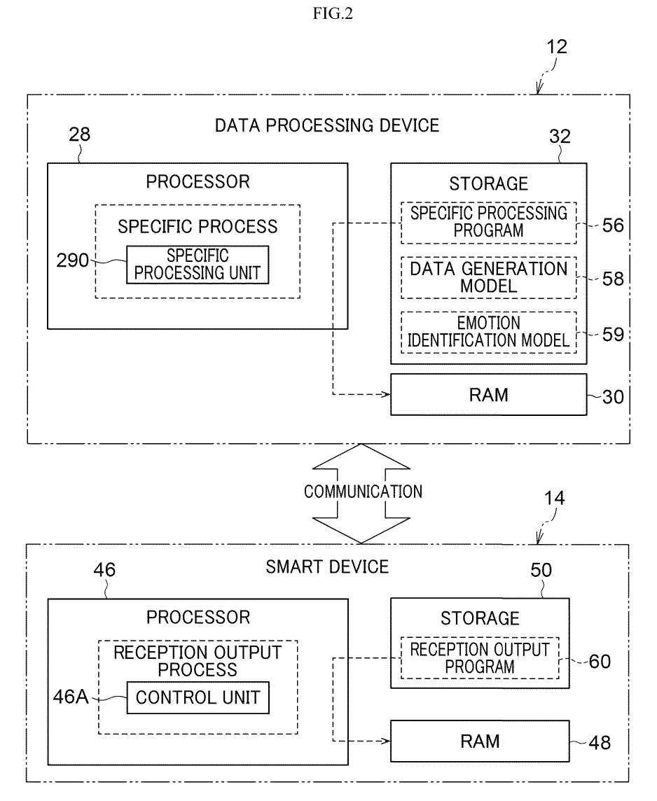

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Online communication services generate large volumes of heterogeneous content, including text, images, and videos, in which harmful communication such as harassment and defamation is often embedded in complex conversational context. Conventional content moderation systems typically rely on keyword-based filters or static classification models that operate on isolated text snippets. Such systems suffer from multiple technical deficiencies: they cannot robustly aggregate multimodal content into a unified textual representation; they do not exploit detailed contextual and historical information; they cannot adapt detection behavior or support messages based on user feedback; and they cannot automatically generate structured legal documents and personalized mental care messages in a verifiable and secure manner.

Moreover, conventional systems treat content analysis, evidence preservation, legal document preparation, and user support as disjoint processes, often implemented as separate modules with inconsistent data formats and no unified control of prompt generation for a generative AI model. As a result, overall processing requires substantial manual intervention, exhibits latency and inconsistency, and does not provide end-to-end traceability or cryptographic integrity guarantees for stored evidence.

From a computer technology standpoint, there is a need for an improved information processing architecture that (i) normalizes and aggregates heterogeneous content types into analysis-ready character information, (ii) programmatically constructs and adapts prompt sentences for a generative AI model based on rich feature information and history information, (iii) automatically generates and securely stores structured evidence and legal document information with integrity metadata, and (iv) continuously refines both harmful communication detection and mental care message generation based on evaluation information from user interaction. Without such an integrated architecture, computer resources are used inefficiently, classification accuracy remains limited by rigid rules, and the system cannot dynamically optimize its processing behavior for each affected subject.

The specific processing by the specific processing unit 290 of the data processing device 12 in Example 1 is realized by the following means.

The present invention provides a server comprising a processor configured to acquire post information from an information providing apparatus via a communication network, normalize the post information into an internal representation including identification information, time information, medium type information, and content information, and store the internal representation in a storage area; to transform image information and video information into character information by executing image analysis processing and voice recognition processing, integrate the extracted character information with existing character information, and generate analysis character information for unified natural language processing; to execute language analysis processing including morphological analysis, lexical classification, emotion evaluation, and target entity extraction on the analysis character information, generate feature information for each post information associated with a monitoring target entity, and store the feature information; to construct multiple prompt sentences including a first prompt sentence describing analysis target information composed of the feature information and the analysis character information, input the prompt sentences and associated data into a generative AI model, and obtain determination information indicating whether post information corresponds to harmful communication together with type, target entity, and severity; to generate and store, for harmful communication post information, evidence information to which hash value information and encryption information are added, and to aggregate multiple harmful communication post information into case information with assigned identification information; to construct further prompt sentences that include structured information summarizing the case information and the evidence information, input the structured information into the generative AI model to generate draft document information for legal procedures, and securely store legal document information generated by arranging the draft document information in template format information; to construct additional prompt sentences for estimating state information indicating a psychological state of an affected subject and support policy information based on case information, harmful communication post information, and response information from the affected subject, and to store the state information and the support policy information per affected subject; and to construct prompt sentences that instruct content and expression style of a mental care message using support condition information including the state information, the support policy information, attribute information of the affected subject, and notification setting information, input the prompt sentences into the generative AI model to generate the mental care message, notify the mental care message to an output apparatus, receive evaluation information from the output apparatus, and update the support policy information and the prompt sentences based on the evaluation information. This enables an integrated, computer-implemented workflow that unifies multimodal content normalization, generative AI-based harmful communication detection, cryptographically verifiable evidence management, automated legal document drafting, and adaptive mental care message generation, thereby improving efficiency, accuracy, and adaptability of the underlying information processing system.

The term “information providing apparatus” refers to a hardware and software system, such as a server or service platform, that provides post information via a communication network through an application programming interface or other data access mechanism.

The term “communication network” refers to a wired or wireless data transmission infrastructure, including at least one of a local area network, a wide area network, and a public packet-switched network, through which digital information is exchanged between the server and external devices.

The term “post information” refers to digital content and associated metadata generated on an online communication service, including at least text data, image data, video data, identification information, time information, and reaction information.

The term “internal representation” refers to a structured data format in which post information acquired from an external source is normalized into machine-readable fields, including identification information, time information, medium type information, and content information, for storage and processing within the server.

The term “identification information” refers to data that uniquely or quasi-uniquely identifies an entity in the system, including at least one of a post identifier, a user identifier, a case identifier, and a device identifier.

The term “time information” refers to data representing a time or time range associated with an event, including at least one of a post creation time, a detection time, an evidence storage time, and a case aggregation time.

The term “medium type information” refers to data indicating a type or combination of types of content included in post information, including at least one of text, image, audio, and video.

The term “content information” refers to the substantive data of a post, including at least character information, image information, audio information, and video information.

The term “character information” refers to text data represented in a character encoding scheme, including characters, symbols, and punctuation that can be processed by natural language processing techniques.

The term “image information” refers to visual data such as still pictures, photographs, and graphical content encoded in a digital image format.

The term “video information” refers to time-varying visual data, optionally including associated audio data, encoded in a digital video format.

The term “analysis character information” refers to a unified text dataset obtained by integrating original character information of a post with character information extracted from image information and video information, which is used as input to language analysis processing.

The term “storage area” refers to one or more logical or physical memory regions, including volatile and non-volatile storage, configured to store internal representations, analysis results, evidence information, case information, and document information.

The term “language analysis processing” refers to a sequence of computational procedures applied to analysis character information, including at least morphological analysis, lexical classification, emotion evaluation, and target entity extraction.

The term “morphological analysis” refers to processing that segments text into units such as words or morphemes and determines grammatical attributes such as part-of-speech for each unit.

The term “lexical classification” refers to processing that categorizes words, phrases, or expressions into predefined lexical or semantic classes, such as offensive expressions, neutral expressions, or supportive expressions.

The term “emotion evaluation” refers to processing that estimates an affective state or sentiment associated with text, including at least polarity, intensity, and emotion category.

The term “target entity extraction” refers to processing that identifies and labels entities mentioned in text, including at least persons, groups, organizations, and other subjects that may be targets of harmful communication.

The term “monitoring target entity” refers to an entity, such as a particular person or group, designated in advance for which harmful communication is to be detected and analyzed.

The term “feature information” refers to structured data derived from language analysis processing, including at least token-level features, sentiment scores, entity labels, and contextual indicators associated with a post.

The term “generative AI model” refers to a machine-learned computational model configured to receive input data including at least one prompt sentence and to generate output data in natural language or structured format, the model having been trained on a dataset to perform generative tasks such as classification, summarization, and document drafting.

The term “prompt sentence” refers to instruction information expressed in natural language or a combination of natural language and structured tokens, which describes an input condition and an expected output format for the generative AI model.

The term “analysis target information” refers to data provided to the generative AI model as part of a prompt, including at least feature information, analysis character information, and contextual data related to one or more posts.

The term “determination information” refers to output data obtained from the generative AI model indicating a classification or assessment result, including at least whether post information corresponds to harmful communication, a type of harmful communication, a target entity, and a severity value.

The term “harmful communication” refers to digital content that is determined to be abusive, harassing, defamatory, or otherwise injurious toward a target entity, as evaluated by the system.

The term “harmful communication post information” refers to post information that has been classified, based on determination information, as corresponding to harmful communication.

The term “evidence information” refers to structured data generated for preservation of harmful communication, including at least content information, time information, posting subject identification information, and determination information.

The term “posting subject identification information” refers to data identifying a creator or sender of a post, including at least an account identifier, user identifier, or similar attribute.

The term “hash value information” refers to a value computed by applying a predetermined hash function to data, used to detect tampering or verify integrity of the data.

The term “encryption information” refers to data indicating a cryptographic protection state, including at least encryption keys, encryption parameters, or references to cryptographic operations applied to stored information.

The term “case information” refers to data representing an aggregation of multiple harmful communication post information related to at least one target entity and time range, including identifiers, aggregated metrics, and references to associated evidence information.

The term “structured information” refers to machine-readable data in a predefined schema summarizing case information and evidence information, suitable for input to a generative AI model or for use in document generation.

The term “draft document information” refers to text or structured content generated by the generative AI model that serves as a preliminary version of a legal document to be used in a legal procedure.

The term “template format information” refers to a predefined document structure including layout, sections, and placeholders into which draft document information is inserted to form a finalized document.

The term “legal document information” refers to data representing a formal document intended for use in a legal procedure, including at least a complaint, notice, or report generated based on draft document information and template format information.

The term “affected subject” refers to an entity, such as an individual user, that is determined to be a victim or potential victim of harmful communication.

The term “response information” refers to data received from an affected subject or a device operated by the affected subject, including at least feedback messages, ratings, or answers to questions related to harmful communication or mental state.

The term “state information” refers to data indicating an estimated psychological state or condition of an affected subject, including, for example, emotional state categories and stress levels.

The term “support policy information” refers to data representing a recommended strategy or guideline for supporting an affected subject, including at least tone, frequency, and type of mental care messages.

The term “support condition information” refers to data used to generate a mental care message, including at least state information, support policy information, attribute information of an affected subject, and notification setting information.

The term “attribute information of the affected subject” refers to profile data related to an affected subject, including at least language preference, demographic attributes, and communication preferences.

The term “notification setting information” refers to configuration data specifying how and when messages are to be delivered to an affected subject, including at least channel selection, timing, and frequency.

The term “mental care message” refers to a message generated for the purpose of providing psychological support, reassurance, or guidance to an affected subject, based on state information and support policy information.

The term “output apparatus” refers to any device or component capable of presenting information to an affected subject and/or receiving input from the affected subject, including at least a user terminal, display device, or communication device.

The term “evaluation information” refers to data representing a reaction or feedback from an affected subject or from the output apparatus regarding a mental care message, including at least ratings, usefulness assessments, and free-text comments.

The term “history information” refers to cumulative data related to past processing, including at least context information of post information, reaction information of other users, and past determination information or state information.

The term “context information” refers to data describing surrounding circumstances of a post, including at least previous and subsequent posts, conversation threads, and associated metadata.

The term “reaction information” refers to data indicating responses from other users or systems to post information, including at least replies, endorsements, and other interaction signals.

The term “past determination information” refers to historical determination information previously generated by the generative AI model or other classifiers for related post information or cases.

The term “verification prompt sentence” refers to a prompt sentence that includes history information in addition to current analysis target information, for the purpose of verifying consistency of an existing determination result or estimation result by re-querying the generative AI model.

The term “evaluation index information” refers to data derived by aggregating mental care message content, state information, support policy information, and evaluation information, which is used to quantify performance or effectiveness of support processing and detection processing.

The term “tone information” refers to data specifying a stylistic characteristic of a message, including at least formality level, politeness level, and emotional intensity.

The term “length information” refers to data indicating a desired or actual size of a generated message, including at least number of characters, words, or sentences.

The term “content constraint information” refers to rules or conditions imposed on content to be generated by the generative AI model, including at least prohibited expressions, required elements, and structural constraints.

The term “weighting information” refers to numerical or categorical values that adjust relative importance of conditions or instructions within a prompt sentence or processing rule used for detection processing or message generation.

In an embodiment, a server includes at least one processor, a main memory, a non-volatile storage device, and a network interface. The server executes an operating system such as a general-purpose server operating system and executes application programs implemented, for example, in a high-level programming language. The server is connected via a communication network to at least one terminal operated by a user, and to at least one information providing apparatus that supplies post information from an online communication service.

The server stores program modules including a data acquisition module, a pre-processing module, a language analysis module, a case management module, an evidence management module, a document generation module, and a mental care control module. Each module is implemented as executable code or microservices that exchange data via defined application programming interfaces and shared data structures stored in a database system such as a relational database management system or a document-oriented database.

The server uses specific hardware accelerators to improve processing efficiency. For example, the server uses a graphics processing unit with a parallel computation architecture to perform matrix operations required by neural network inference and training. The server uses a network interface controller to send and receive HTTP or HTTPS packets with social media application programming interfaces and with terminals. The server uses a storage controller and non-volatile storage to maintain encrypted evidence information and legal document information.

The server uses specific software libraries to perform data processing. For example, the server uses an HTTP client library to acquire JSON-formatted post information from an application programming interface of an information providing apparatus. The server uses an image analysis library such as a computer vision library to decode image information and apply optical character recognition algorithms. The server uses a media processing tool such as a multimedia framework to extract audio tracks and key frames from video information. The server uses a speech recognition engine such as a neural network based automatic speech recognition model to convert audio to character information. The server uses a natural language processing framework such as a language processing toolkit to perform tokenization, part-of-speech tagging, and named entity recognition on analysis character information. The server uses a cryptographic library such as a general-purpose crypto library to compute hash values, perform symmetric-key encryption, and manage encryption keys.

The server uses a generative AI model deployed either as a remote service or as a locally hosted neural network. In one embodiment, the generative AI model is a transformer-based neural network including a plurality of encoder layers and a plurality of decoder layers, each layer including multi-head self-attention mechanisms, feed-forward sublayers, layer normalization, and residual connections. The generative AI model uses token embeddings and position embeddings as input representations and outputs probability distributions over token vocabularies. The server converts prompt sentences and analysis character information into token sequences, feeds the token sequences to the transformer model, and obtains output token sequences that represent determination information, draft document information, state information, and mental care messages.

The server trains or fine-tunes the generative AI model using supervised learning on training datasets that contain pairs of input prompt sentences and desired output sequences. The server defines a loss function such as cross-entropy loss that measures a difference between predicted token probabilities and ground-truth tokens. The server applies backpropagation through time and an optimization algorithm such as stochastic gradient descent with adaptive learning rate adjustment to update weight parameters of the transformer layers. The server optionally uses data augmentation methods such as paraphrasing, noise injection, and sampling of different harassment scenarios to improve robustness. The server stores learned weight parameters in the storage device and loads the parameters into the GPU memory for inference.

The server designs rule-based pre- and post-processing pipelines that are not simple automation of human reading. For example, the server defines a feature vector for each post that includes numeric values for sentiment scores, frequency counts of offensive lexical categories, context window lengths, and interaction densities. The server combines these feature vectors with embedding vectors from the generative AI model in a non-conventional way, by adjusting prompt sentences using parameterized templates that depend on feature magnitudes. In particular, when sentiment strength and interaction density exceed thresholds, the server modifies the prompt sentence to request more detailed explanations from the generative AI model. This conditional prompt adaptation is implemented as deterministic algorithms on structured feature information, which reduces unnecessary computation for benign posts and focuses computational resources on high-risk content.

The server stores internal data structures in explicit formats. For example, the server stores post information in a table including fields such as post identifier, user identifier, platform identifier, time information, medium type information, and content information. The server stores analysis character information in a separate table that references the post identifier and includes normalized text strings. The server stores feature information in a feature table that includes numeric and categorical fields such as sentiment score, offensive expression category, target entity identifier, and context length. The server stores harmful communication post information with explicit flags and references to case information.

The server uses specialized algorithms for aggregation and case formation. The server uses an index on target entity identifiers and time fields to perform range queries and group posts into case information. The server computes rolling windows over time to detect bursts of harmful communication and assigns weights to posts based on severity scores from determination information. The server calculates case-level metrics such as weighted severity sums and peak rates using vectorized database operations. This structured aggregation leads to efficient retrieval of representative evidence and reduces data volume transmitted to terminals and legal representatives.

The server generates prompt sentences for the generative AI model in a programmatic manner using templates and parameter substitution. For example, the server generates a prompt sentence for detection of harmful communication as follows: “Analyze the following social media post and its context. Determine whether it contains harassment or defamation against the monitored user. Return JSON with fields: is_harassment, harassment_type, target_user, severity_score, and explanation.”

In another example, the server generates a prompt sentence for legal document drafting as follows:
“Using the following case summary and evidence list, draft a formal legal complaint suitable for submission to a court. Use neutral and factual language, avoid speculation, and structure the document with sections for parties, facts, legal grounds, and demands.”

In another example, the server generates a prompt sentence for mental state estimation as follows:
“Based on the following harassment history and the victim's recent feedback messages, estimate the victim's current emotional state and risk level. Return JSON with fields: emotional_state, stress_level, and recommended_support_tone.”

In another example, the server generates a prompt sentence for mental care message generation as follows:
“The victim is currently feeling anxious and overwhelmed due to repeated online harassment. Generate a brief, empathetic mental-care message. Avoid medical diagnoses, do not give medical or legal advice, and encourage seeking professional counseling if distress is severe.”

The server does not simply forward raw posts to the generative AI model. Instead, the server constructs prompt sentences using feature information, history information, and structured information. For example, the server generates a verification prompt sentence that includes prior determination information and state information to request the generative AI model to re-evaluate consistency:
“Given the previous classification results and the following new context, verify whether the prior harassment determination remains valid. If not, update the severity_score and provide a short explanation.”

By explicitly encoding such verification steps in deterministic algorithms, the server reduces model hallucination errors and increases the reliability of the classification process. The server uses thresholds on conditional probabilities and differences between past and new severity scores to decide whether to update harmful communication post information.

The server computes hash value information for evidence information using a secure hash algorithm. The server concatenates content information, time information, posting subject identification information, and determination information into a byte sequence and calculates a hash value. The server stores the hash value with the evidence information and, in some embodiments, computes a chain of hash values similar to a ledger arrangement, so that tampering of older evidence can be detected by verifying a hash chain. The server uses symmetric-key encryption algorithms such as a block cipher with a 256-bit key to encrypt evidence information and legal document information before storing them in non-volatile storage. This cryptographic design ensures integrity and confidentiality, which are technical properties of the computer system.

The server uses message queues or asynchronous task schedulers to decouple data acquisition and heavy computational procedures such as generative AI model inference and document generation. This design reduces blocking time and allows multiple posts and cases to be processed concurrently, thereby improving throughput. The server schedules GPU-intensive tasks based on queue priorities, giving preference to harmful communication detection over non-critical background tasks. This scheduling logic improves resource utilization and reduces latency in detection, which is a technical improvement over sequential or ad-hoc processing.

The server implements caching of frequently accessed feature information and state information in a memory cache. When the server constructs prompt sentences for related posts, the server reuses cached embeddings and analysis results rather than recomputing them. This reduces CPU and GPU load and lowers communication traffic with external model services, thereby reducing overall power consumption and improving responsiveness.

The server uses feedback from the terminal, provided as evaluation information, to adapt prompt sentences and support policy information. The server aggregates helpful/not helpful labels across many messages and calculates evaluation index information such as average helpfulness by tone and length. The server updates parameters in prompt templates, for example by increasing the allowed length of messages for victims who frequently rate longer messages as helpful. This update is performed by adjusting explicit numeric parameters in the prompt construction algorithm, not only by retraining the generative AI model. This separation of model weights and prompt logic allows rapid adaptation and constitutes an improvement in system configurability and maintainability.

The terminal is a computing device such as a smartphone, tablet, or personal computer including a processor, a display, an input interface, and a communication function. The terminal executes an application that communicates with the server. The terminal receives mental care messages, case summaries, and legal document status information from the server via a communication network. The terminal displays the received information to a user and transmits response information and evaluation information back to the server.

The terminal uses an operating system interface to receive push notifications and to present them in notification areas and custom user interfaces. The terminal stores certain data locally in a secure storage area, such as tokens for authentication, minimal logs, and user preferences. The terminal performs user interface rendering by converting JSON responses from the server into visual components such as lists, timelines, and message views. The terminal provides buttons or input fields for the user to submit feedback; when the user taps a control, the terminal sends a structured request to the server.

The user operates the terminal to configure monitoring preferences, to view cases, and to interact with mental care messages. For example, the user selects notification channels, selects time windows during which messages are permitted, and sets language preferences. The user may open a screen that lists harmful communication posts associated with a case and review the corresponding evidence information summarized by the server. The user may preview legal document information generated by the server, and may trigger a workflow to export the document to an external storage or to share it with a representative. The user may read mental care messages and provide explicit feedback such as “This was helpful” or enter free-text comments about current feelings; the terminal transfers such feedback to the server, which updates support policy information and prompt strategies.

In alternative embodiments, the generative AI model is deployed on the same server, in a cluster of servers, or as a cloud-based service managed by a different computing infrastructure. In some embodiments, the generative AI model is not a transformer architecture but a recurrent neural network, a convolutional sequence model, or a mixture-of-experts model. In some embodiments, the language analysis module uses other machine learning models such as gradient boosting decision trees to derive feature information, and the generative AI model focuses only on natural language generation for explanations and documents. In another variation, the OCR engine for image information is replaced with a deep convolutional neural network with an attention mechanism optimized for text recognition in noisy social media images. In yet another embodiment, the speech recognition component uses a hybrid architecture combining recurrent layers and convolutional layers to reduce error rates on informal speech.

The server in all these embodiments operates according to the same overall design principles: the server integrates heterogeneous sensor-like inputs (text, image, audio, video), converts them into analysis character information and structured feature information, uses a generative AI model in conjunction with deterministic algorithms and explicit prompt sentences, and performs storage, encryption, aggregation, and document generation in a way that reduces human error, increases throughput, and enables consistent and repeatable workflows. The causal relationship between these design choices and the resulting technical effects is as follows: by structuring feature information and history information and tightly controlling formats of prompt sentences, the server reduces ambiguous inputs to the neural network model, which decreases misclassification rates and improves precision in harmful communication detection; by employing GPU acceleration and asynchronous job scheduling, the server reduces overall processing time per post; by applying hash chains and encryption, the server ensures that evidence information retains integrity and confidentiality across long-term storage; by aggregating evaluation information and adapting prompts and support policies, the server continuously tunes communication parameters without requiring modification of internal model weights for every change, which shortens adaptation cycles and reduces computational overhead.

Accordingly, the server, the terminal, and the user cooperate in a technical system that is not limited to abstract data manipulation. The system performs specific operations on network interfaces, graphical rendering devices, non-volatile storage, and specialized accelerators, and achieves improved processing speed, higher accuracy of harmful communication detection, better data management for evidence, and optimized use of communication and computation resources.

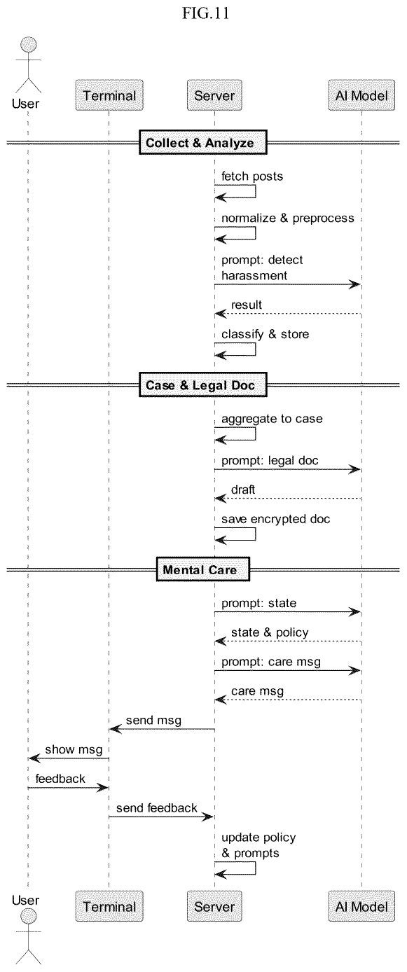

The following describes the processing flow using FIG. 11.

### Step 1:

Server receives post information from an information providing apparatus via a communication network.

Server uses an HTTP client to send a request including query parameters such as monitored keywords, account identifiers, and time ranges, and server receives a response including raw JSON data for posts, comments, and associated metadata.
Input: API response containing raw post information (JSON with post IDs, user IDs, timestamps, media URLs, and text captions).
Output: Internal data objects representing posts, each including identification information, time information, medium type information, and content information.

Server parses the JSON, extracts required fields, and converts them into internal records stored in a database table, for example “raw_posts.”

### Step 2:

Server normalizes the post information into an internal representation.

Server maps platform-specific fields (for example, “tweet_id,” “post_id,” “created_at”) into unified fields such as “post_identifier” and “post_timestamp.”
Input: Internal data objects containing raw platform-specific fields.
Output: Normalized records containing identification information, time information, medium type information, and content information in a consistent schema.

Server determines medium type information by inspecting media fields and flags each record as text-only, image-containing, video-containing, or mixed, and server stores the normalized records in a “posts” table.

### Step 3:

Server pre-processes text-only posts.

Server detects that the medium type is text-only and sends the text body to a natural language preprocessing library.
Input: Normalized post record with content information consisting of character information.
Output: Cleaned text string with standardized encoding, normalized whitespace, and removed control characters, stored as analysis character information.

Server applies operations such as lowercasing, Unicode normalization, URL and hashtag token replacement, and stores the resulting analysis character information in an “analysis_text” field associated with the post record.

### Step 4:

Server pre-processes posts including image information.

Server downloads image data from the media URL and applies an OCR engine to detect and recognize characters within the image.
Input: Normalized post record with content information including image information and possibly caption text.
Output: Extracted OCR text and a combined text string that merges OCR text with caption text.

Server concatenates the caption text with OCR text separated by delimiters, and server stores this combined text as analysis character information linked to the original post.

### Step 5:

Server pre-processes posts including video information.

Server downloads the video file or accesses a streaming endpoint, uses a media processing tool to extract the audio track and selected key frames, and passes the audio track to a speech recognition engine to obtain transcribed text.
Input: Normalized post record with content information including video information and optionally a textual description.
Output: Transcribed speech text and any text extracted from video frames, merged into a single analysis character information string associated with the post.

Server stores the transcribed and extracted text fields, along with status flags for OCR and speech recognition completion, in dedicated database fields.

### Step 6:

Server generates unified analysis character information.

Server integrates original character information from captions, OCR text from images, and transcription text from video audio into a single field.
Input: Multiple partial text sources (caption text, OCR text, transcription text) linked to the same post.
Output: A single analysis character information field used for subsequent language analysis.

Server inserts delimiters or markers indicating source segments to preserve source context while enabling unified processing.

### Step 7:

Server performs language analysis processing on the analysis character information.

Server uses a natural language processing toolkit to tokenize the analysis character information into words or subword units, assign part-of-speech tags, perform lemmatization, and detect named entities such as person names and organizations.
Input: Analysis character information for a post.
Output: Structured linguistic annotations including token sequences, part-of-speech tags, lemmas, and entity labels.

Server calculates sentiment scores using a sentiment classifier and stores features such as sentiment polarity and intensity associated with the post identifier.

### Step 8:

Server generates feature information for each post.

Server computes numerical and categorical features including sentiment score, counts of offensive lexical categories, presence of monitored target entity names, context length (number of tokens), and interaction density (for example, number of replies or reactions).
Input: Linguistic annotations (tokens, POS tags, entities), reaction counts, and monitoring target entity list.
Output: Feature information record including structured numerical and categorical fields linked to the post identifier.

Server saves each feature information record in a “post_features” table or similar data structure.

### Step 9:

Server identifies posts associated with a monitoring target entity.

Server compares extracted entity labels with entries in a monitoring target entity list stored in a configuration table.
Input: Feature information with entity labels and a monitoring target entity list.
Output: A subset of posts marked as candidate posts for harmful communication detection, with references to specific target entities.

Server sets a flag such as “candidate_for_detection=true” in records that mention a monitored entity.

### Step 10:

Server constructs a first prompt sentence for harmful communication detection.

Server generates a text instruction that includes analysis character information, summary of feature information (sentiment score, offensive term counts), and context information of the post (for example, parent post or thread summary).
Input: Candidate post record, analysis character information, feature information, and context information.
Output: A first prompt sentence string describing the detection task and required output format for the generative AI model.

Server embeds placeholders in a template and fills them with actual values, creating a task-specific prompt sentence.

### Step 11:

Server sends the first prompt sentence and analysis character information to the generative AI model.

Server converts the prompt sentence and text into tokens, transmits them via an application programming interface to the generative AI model, and waits for an output sequence.
Input: First prompt sentence text and associated analysis character information.
Output: Generated output text containing determination information such as is_harassment, harassment_type, target_user, severity_score, and explanation.

Server parses the output text according to predefined markers and converts it into structured determination information.

### Step 12:

Server classifies harmful communication post information based on determination information.

Server checks fields such as is_harassment and severity_score and applies thresholds to decide whether a post is harmful communication.
Input: Determination information associated with a candidate post.
Output: An updated post record with a harmful communication flag, stored in a “harmful posts” or equivalent table, or marked as safe content.

Server records additional details such as harassment type and explanation for later use in evidence generation and reporting.

### Step 13:

Server generates evidence information for harmful communication posts.

Server collects content information, time information, posting subject identification information, and determination information for each harmful communication post.
Input: Harmful communication post records and determination information.
Output: Evidence information objects containing all relevant metadata and content snapshots.

Server creates a structured representation such as a record or document that includes text content, media references, and classification results.

### Step 14:

Server secures evidence information by applying hash and encryption.

Server concatenates selected fields of evidence information into a byte sequence, computes a hash value, and attaches the hash value to the evidence information.
Input: Evidence information object for a harmful communication post.
Output: Evidence information extended with hash value information and ciphertext form of the evidence object.

Server encrypts the evidence information using a symmetric-key cryptographic algorithm and stores the encrypted blob and hash value in a secure evidence store.

### Step 15:

Server aggregates harmful communication posts into case information.

Server performs database queries using target entity identifiers and time ranges to group harmful communication posts into clusters that represent cases.
Input: Harmful communication post records and associated metadata.
Output: Case information records each containing references to multiple harmful communication posts, summary statistics, and a case identifier.

Server calculates metrics such as total number of harmful posts, average severity, peak period, and main attackers, and stores these in the case information record.

### Step 16:

Server generates structured information summarizing case information and evidence.

Server compiles, for each case, a list of evidence items, a timeline of key events, and the case-level metrics into a machine-readable summary.
Input: Case information records and associated evidence information.
Output: Structured information describing each case in a concise schema suitable for input to the generative AI model.

Server stores this structured information in a dedicated “case_summary” or equivalent table.

### Step 17:

Server constructs a second prompt sentence for legal document drafting.

Server creates an instruction text that requests a formal legal document based on structured information.
Input: Structured information for a case, including evidence lists and metrics.
Output: A second prompt sentence that specifies document type, required sections, language style, and constraints.

Server follows a template such as: “Using the following case summary and evidence list, draft a formal legal complaint suitable for submission to a court. Use neutral and factual language, avoid speculation, and structure the document with sections for parties, facts, legal grounds, and demands.”

### Step 18:

Server sends the second prompt sentence and structured information to the generative AI model.

Server concatenates the second prompt sentence with a textual representation of the structured information and transmits this combined text to the generative AI model.
Input: Second prompt sentence and structured case information in textual form.
Output: Draft document information as natural language text representing a legal complaint or similar legal document.

Server receives and stores the generated draft document information as a text field linked to the case identifier.

### Step 19:

Server generates legal document information from draft document information.

Server inserts the draft document information into a document template, populates fixed fields such as dates and names of parties, and formats headings and sections.
Input: Draft document information and template format information.
Output: Final legal document information in a structured document format such as a word processing file or a PDF-ready representation.

Server encrypts the final legal document information and stores it in a secure document repository with references to the related case information.

### Step 20:

Server constructs a third prompt sentence for mental state estimation.

Server summarizes recent harassment events, case severity, and user feedback into an input description for the generative AI model.
Input: Case information associated with an affected subject, harmful communication post information, and response information from the affected subject.
Output: A third prompt sentence that instructs the generative AI model to estimate emotional_state, stress_level, and recommended_support_tone.

Server formats the harassment history and feedback excerpts as part of the prompt text, following, for example: “Based on the following harassment history and the victim's recent feedback messages, estimate the victim's current emotional state and risk level. Return JSON with fields: emotional_state, stress_level, and recommended_support_tone.”

### Step 21:

Server sends the third prompt sentence and response information to the generative AI model.

Server provides the prompt sentence and embedded user feedback text as input to the model and obtains estimation results.
Input: Third prompt sentence and response information content.
Output: State information including emotional_state and stress_level, and support policy information including recommended_support_tone and suggested support intensity.

Server parses the model's output and stores the state information and support policy information in a “mental_state” table keyed by the affected subject identifier.

### Step 22:

Server constructs a fourth prompt sentence for mental care message generation.

Server uses state information, support policy information, user attribute information, and notification setting information to define content style and constraints of a support message.
Input: State information, support policy information, and user profile data.
Output: A fourth prompt sentence instructing the generative AI model to generate an appropriate mental care message.

Server may use a template such as: “The victim is currently feeling anxious and overwhelmed due to repeated online harassment. Generate a brief, empathetic mental-care message. Avoid medical diagnoses, do not give medical or legal advice, and encourage seeking professional counseling if distress is severe.”

### Step 23:

Server sends the fourth prompt sentence to the generative AI model and obtains a mental care message.

Server feeds the prompt sentence to the generative AI model and waits for a generated text response.
Input: Fourth prompt sentence including guidance on tone, length, and constraints.
Output: A mental care message text tailored to the affected subject's state and preferences.

Server logs the generated message and tags it with the corresponding state information and support policy information.

### Step 24:

Server applies safety and quality checks to the mental care message.

Server runs the message through a separate content filter or toxicity detection model and verifies that it does not contain prohibited terms or harmful advice.
Input: Generated mental care message text.
Output: Either an approved mental care message ready for delivery or a flagged message requiring regeneration or modification.

Server discards or regenerates any message that fails quality checks and only retains approved messages for delivery.

### Step 25:

Server delivers mental care messages to the terminal.

Server selects communication channels based on the user's notification setting information and constructs appropriate delivery payloads.
Input: Approved mental care message text, user identifier, and notification setting information.
Output: Network messages such as push notifications, in-app messages, or emails sent to the terminal.

Server records delivery events including timestamps and delivery status in a log table.

### Step 26:

Terminal receives and displays mental care messages.

Terminal obtains notification payloads from a push notification service or from a server API endpoint and renders the message content in a user interface component.
Input: Network payload containing mental care message text and metadata.
Output: Displayed content on the terminal screen along with interface controls for user feedback.

Terminal presents options such as “helpful,” “not helpful,” and may provide a text input field for the user to describe feelings.

### Step 27:

User interacts with mental care messages and provides feedback.

User reads the displayed message, assesses its usefulness, and selects a feedback option or enters free-text comments.
Input: Mental care message displayed on the terminal.
Output: User-generated response information and evaluation information such as a helpfulness rating and optional comments.

Terminal collects the selected options and input text for transmission to the server.

### Step 28:

Terminal sends response information and evaluation information to the server.

Terminal creates a structured request containing message identifiers, user identifier, feedback ratings, and comments, and sends it via HTTPS to a feedback endpoint on the server.
Input: User feedback data gathered from the terminal interface.
Output: Network request containing response information and evaluation information delivered to the server.

Terminal may display an acknowledgment to the user after successful transmission.

### Step 29:

Server processes evaluation information and updates support policy information.

Server stores the feedback in a “user feedback” table related to message identifiers and affected subject identifiers.
Input: Evaluation information and references to corresponding mental care messages.
Output: Updated evaluation index information, such as running averages of helpfulness scores per tone or length category.

Server recalculates parameters used in prompt templates, for example, adjusting desired length or tone, and updates support policy information to reflect the affected subject's preferences.

### Step 30:

Server adjusts prompt sentences for future processing based on evaluation index information.

Server updates stored templates and parameter values used in constructing first, third, and fourth prompt sentences, so that future harmful communication detection, state estimation, and mental care message generation better align with observed outcomes.
Input: Evaluation index information derived from aggregated feedback.
Output: Modified prompt construction rules and updated parameter sets used in subsequent calls to the generative AI model.

Server thereby refines both detection and support behavior in a data-driven manner, improving technical performance such as detection accuracy and personalization effectiveness over time.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional monitoring systems that analyze sensor data, such as image streams, typically rely on fixed rule sets or specialized recognition models to detect abnormal events. These systems suffer from several technical limitations. First, the systems must encode complex human behavior patterns into hand-crafted rules or narrowly trained models. As a result, when the monitored environment, behavior patterns, or threat profiles change, the systems require extensive manual reconfiguration or retraining, which degrades scalability and adaptability. Second, such systems often operate in a pipeline where low-level detection modules (for example, object detection and tracking) are decoupled from high-level reasoning, thereby losing rich contextual information, such as temporal relationships and semantic intent, that would be beneficial for accurate abnormality assessment. This decoupling leads to a high false-positive rate and a high false-negative rate, which in turn consumes computation and network resources due to unnecessary alerts and evidence processing. Third, existing systems typically generate fixed-format alerts and reports, which are not dynamically adapted to the specific content of each incident or to the capabilities of downstream devices, thereby increasing the cognitive load on operators and hindering timely decision-making.

Moreover, traditional designs do not effectively exploit generative AI models in a way that is tightly integrated with the upstream data processing pipeline. In many approaches, generative AI models are used only as auxiliary text generators, without being provided with structured, machine-derived summaries of behavior in a controlled prompt format. This results in either underutilization of the models' reasoning capabilities or non-deterministic output that is difficult to map back to the underlying sensor data. Further, there is no closed feedback loop from user input at terminal devices to the low-level detection and high-level prompt design, so the system cannot systematically improve its detection thresholds, behavior aggregation logic, or prompt sentences based on real-world performance. As a consequence, computational resources at the server side are not optimally used, network bandwidth is consumed by irrelevant data transfers, and storage and encryption resources are applied inefficiently to events that are later determined to be benign.

Accordingly, there is a need for a computer-implemented monitoring system that (i) tightly couples object detection and behavior analysis with a generative AI model through structured prompt sentences, (ii) automatically converts time-series observation data and derived behavior patterns into natural language descriptions for high-level reasoning, (iii) selectively generates and securely stores evidence and legal documents only for events determined to be abnormal with a certain risk level, and (iv) closes the loop by using terminal-side feedback to refine detection processing and prompt design. Such a system would improve the technical operation of the server by reducing unnecessary processing and network transmissions, increasing the precision of abnormal event detection, and enabling more efficient generation and protection of incident-related data and documents.

The specific processing by the specific processing unit 290 of the data processing device 12 in Application Example 1 is realized by the following means.

The present invention provides a server comprising a processor configured to acquire observation data regarding a monitored area from one or more information acquisition devices; perform object detection processing and behavior analysis processing on the acquired observation data to extract abnormal event candidates based on behavior patterns of subjects; convert attribute information and time-series information related to the extracted abnormal event candidates into natural language expressions, generate a prompt sentence including the natural language expressions, and input the prompt sentence to a generative AI model to obtain evaluation information regarding at least an abnormality level, an abnormality type, and a response action; determine an abnormal event based on the evaluation information, generate evidence information including time information, location information, identification information, and related observation data associated with the abnormal event, store the evidence information in a storage unit, and generate document data for use in legal procedures based on the evidence information and, optionally, on output content from the generative AI model; generate warning messages and support messages for related persons based on the determined abnormal event and the evaluation information, and distribute the warning messages and the support messages to a terminal device; and collect feedback information input from the terminal device and update at least one of the object detection processing, the behavior analysis processing, and contents of the prompt sentence based on the feedback information. This enables a technically improved monitoring operation in which the server efficiently integrates low-level sensor data processing with high-level generative AI reasoning, reduces false positives and false negatives by using structured prompts and feedback-driven refinement, minimizes unnecessary computation, communication, and storage by selectively generating and encrypting evidence and documents only for confirmed abnormal events, and dynamically adapts alert and report generation to the context of each incident and to real-world user interactions.

The term “observation data” refers to data representing a state of a monitored area over time, including at least time-series image data and optionally other sensor data such as audio, depth, or environmental measurements, acquired by one or more information acquisition devices.

The term “monitored area” refers to a physical space, such as an interior or exterior facility region, corridor, entrance, or zone, that is subject to surveillance by one or more information acquisition devices.

The term “information acquisition device” refers to a hardware device configured to capture observation data, such as an imaging device, a surveillance camera, or another sensor that outputs time-series data representing the monitored area.

The term “time-series image data” refers to a sequence of image frames acquired over time from an information acquisition device, including video streams or periodically captured still images with associated timestamps.

The term “object detection processing” refers to processing that analyzes observation data to detect and localize one or more subjects or objects of interest, such as persons or movable items, and outputs information including at least class labels, positions, and detection confidence values.

The term “behavior analysis processing” refers to processing that analyzes temporal changes in detection results for one or more subjects or objects, calculates movement histories and staying times, and derives behavior patterns such as staying, entering, leaving, or moving within predetermined areas.

The term “abnormal event candidate” refers to an event inferred from behavior analysis processing as potentially abnormal according to one or more criteria, such as excessive staying time, entry into a restricted area, or movement inconsistent with typical patterns, prior to confirmation as an abnormal event.

The term “abnormal event” refers to an event determined, based on evaluation information from a generative AI model, to satisfy one or more abnormality conditions, including at least a specified abnormality type and abnormality level, and to warrant evidence generation and notification.

The term “subject” refers to any entity detected and analyzed in observation data, including at least a person, an animal, a vehicle, or another moving or stationary object relevant to monitoring of the monitored area.

The term “attribute information” refers to information describing characteristics of an abnormal event candidate or a subject, including at least identifiers, object classes, locations, zones, durations, and other relevant parameters extracted by the processor.

The term “time-series information” refers to information representing temporal sequences associated with abnormal event candidates or subjects, including movement histories, staying times, entry and exit times, and time-aligned detection results.

The term “natural language expression” refers to a textual representation in a human language that describes observation data, behavior patterns, or event attributes in a form understandable by humans and processable by a generative AI model.

The term “prompt sentence” refers to a text or set of texts, including at least one natural language expression and one instruction sentence, that is constructed for input to a generative AI model to request analysis, evaluation, or document generation.

The term “instruction sentence” refers to a part of a prompt sentence that explicitly instructs the generative AI model regarding a required task, such as determining abnormality, assigning a risk level, recommending a response, or generating a report.

The term “generative AI model” refers to a machine learning model configured to generate text or other content in response to an input prompt sentence, including at least a large-scale language model capable of reasoning about behavior descriptions and producing evaluation information or document text.

The term “evaluation information” refers to information output from the generative AI model in response to a prompt sentence, including at least an abnormality level, an abnormality type, and a recommended response action, and optionally further explanatory or classification data.

The term “abnormality level” refers to an indication of severity or risk associated with an abnormal event candidate or abnormal event, expressed, for example, as a numerical scale or categorical level.

The term “abnormality type” refers to a classification category assigned to an abnormal event candidate or abnormal event, such as loitering, unauthorized entry, trespassing, or other defined abnormal behavior types.

The term “response action” refers to a recommended operation for personnel or systems in response to an abnormal event, such as dispatching staff, initiating additional monitoring, contacting authorities, or logging the event for later review.

The term “evidence information” refers to information generated for a determined abnormal event, including at least time information, location information, identification information, and related observation data segments, for use in later review, compliance, or legal procedures.

The term “time information” refers to information indicating at least one point in time or a time interval associated with an event, such as an event start time, end time, or duration.

The term “location information” refers to information identifying a place or region associated with an event or a subject, including at least a monitored area identifier, device identifier, zone label, or other spatial reference.

The term “identification information” refers to information that distinguishes or associates a subject or event, including at least identifiers such as subject IDs, track IDs, incident IDs, or links to reference records.

The term “storage unit” refers to a hardware and software configuration for storing digital data, including system memory, nonvolatile storage, or networked storage capable of storing evidence information and document data.

The term “document data” refers to structured or unstructured digital data representing a document, such as an incident report, a summary report, or a legal document, generated based on evidence information and optionally on output from a generative AI model.

The term “warning message” refers to a notification message generated for related persons or systems to indicate existence or possibility of an abnormal event and to request or enable a responsive action.

The term “support message” refers to a message generated to assist related persons in handling or understanding an abnormal event, including, for example, explanatory information, recommended procedures, or guidance.

The term “terminal device” refers to a computing device operated by or accessible to a user, including at least a portable terminal, a stationary terminal, or another user interface device configured to receive messages and send feedback.

The term “feedback information” refers to information transmitted from a terminal device to the server, including at least user-confirmed classifications of events, assessments such as false alarms or confirmed incidents, comments, or other responses used to refine system behavior.

The term “metadata” refers to auxiliary data describing evidence data or document data, including at least timestamps, device identifiers, hash values, event identifiers, and other descriptive attributes.

The term “encryption processing” refers to processing that transforms evidence data or document data using a cryptographic algorithm and key so as to restrict access to authorized entities and protect confidentiality and integrity.

The term “report document” refers to a document generated for human consumption based on metadata, evidence information, and output from a generative AI model, including at least incident reports, summaries, or documents suitable for submission to an external authority.

The term “processor” refers to one or more hardware processing units, such as a central processing unit, a graphics processing unit, or specialized circuitry, configured to execute instructions that implement the object detection processing, behavior analysis processing, prompt generation, communication with the generative AI model, evidence generation, message distribution, and feedback-based updating.

Server, terminal, and user cooperate to implement embodiments of the invention as described below. Each embodiment supports the claimed system and illustrates concrete hardware, software, data structures, and processing flows. No single embodiment is limiting.

Server is implemented as an electronic computing apparatus including at least one central processing unit (CPU), at least one graphics processing unit (GPU) or other parallel processor, a main memory, a nonvolatile storage device, and one or more network interfaces. For example, server uses a general-purpose CPU such as a multi-core processor, a parallel processor such as a graphics processing device, a volatile memory such as a random access memory module, and a nonvolatile memory such as a solid-state storage device. Server executes an operating system such as a general-purpose server operating system, and executes application programs including a detection module, a behavior analysis module, a prompt generation module, a generative AI communication module, an evidence management module, a document generation module, and a notification/feedback module.

Terminal is implemented as a mobile computing apparatus or a stationary computing apparatus including a processor, a memory, a display, an input device such as a touch panel, a wireless or wired communication interface, and optionally a speaker or vibration actuator. Terminal executes a client application that communicates with server by a network protocol and presents incident-related information to user.

User is a human operator such as a security staff member or administrator who interacts with terminal to review abnormal events, view evidence, and provide feedback to server.

### 1. Hardware and Software Configuration

Server acquires observation data from one or more information acquisition devices. The information acquisition device is implemented as a sensor device such as a surveillance camera, a depth camera, or a multi-modal sensor module. In a typical embodiment, the information acquisition device is a network camera that outputs compressed video streams using a streaming protocol. Server uses a software library such as a multimedia processing library to open a stream from each camera by a network protocol endpoint, decode compressed video frames, and convert them into numerical arrays stored in main memory. Server uses a software framework for numerical computation and deep learning, such as a tensor computation framework, to execute object detection and behavior analysis processing on the GPU. Server stores intermediate detection results, behavioral summaries, and evaluation information in a database management system such as a relational database or a document database. Server uses a network protocol such as a secure hypertext transfer protocol to communicate with an external or internal generative AI model endpoint. In another embodiment, server deploys a generative AI model locally on the GPU and invokes it via the same tensor computation framework, without external network communication.

### 2. Data Structures and Internal Representations

Server represents each frame of time-series image data as a multi-dimensional array in memory, with dimensions corresponding to height, width, and color channels. Server associates each frame with a timestamp and camera identifier. Server represents detection results as a structured record including at least: a frame identifier, a subject identifier, a bounding region (for example, a rectangle defined by pixel coordinates), a class label (for example, person, object type), and a confidence value.

Server represents movement histories as sequences of positions over time. In one embodiment, server stores for each subject identifier an ordered list of entries having fields of timestamp, position coordinates, and zone label. Server defines “zone” as a labeled region within the monitored area (for example, entrance zone, restricted zone). Server stores staying times and transitions between zones as aggregated statistics computed from these sequences.

Server further represents abnormal event candidates as records that include: one or more subject identifiers, a zone or region identifier, a start time and an end time, a raw behavior descriptor (for example, “subject stayed in zone longer than threshold”), and numerical metrics such as duration, distance traveled, or number of entries into a restricted zone. Server later augments these records with evaluation information received from the generative AI model, such as abnormality type and abnormality level, to form abnormal event records.

Server represents evidence information as a record including an incident identifier, pointers to stored observation data segments (for example, file paths or object storage keys), metadata such as timestamps and device identifiers, hash values for integrity verification, and links to generated document data.

### 3. Object Detection and Behavior Analysis as Technical Processing

Server uses an object detection model implemented as a neural network, for example a convolutional neural network with a feature extraction backbone and multiple detection heads. The backbone receives a frame tensor as input and outputs multi-scale feature maps. The detection heads predict bounding regions and class probabilities for each cell in the feature maps. The network is trained in advance using supervised learning and stored as a set of weight parameters in nonvolatile storage.

Server loads the model parameters into GPU memory and performs, for each frame, operations such as convolution, activation, pooling, and normalization to compute detection results. Server applies non-maximum suppression to eliminate duplicate detections. These operations are matrix and tensor operations optimized on the GPU, which significantly reduce the processing time compared with a CPU-only implementation and enable near real-time analysis of high-resolution video streams.

Server performs behavior analysis by linking detections across frames. In one embodiment, server uses a state estimation algorithm, such as a Kalman filter, combined with an appearance embedding model to assign consistent identifiers to the same physical subject over multiple frames. Server updates an internal state for each subject identifier, including an estimated position, velocity, and covariance matrix. This allows server to predict short-term future positions and associate detections to existing tracks efficiently, reducing mis-associations and improving tracking robustness compared with naive nearest-neighbor approaches.

Server partitions the monitored area into zones and assigns zone labels to subject positions by coordinate-based region checks. Server computes for each subject a staying time per zone, entry and exit times, and transition sequences between zones. Server compares these metrics with configuration parameters such as allowed stay duration or permitted paths, and generates abnormal event candidates when specific thresholds are exceeded (for example, staying beyond a first threshold or entering a restricted zone without authorization). This algorithmic processing transforms raw pixel data into structured spatio-temporal behavior information, enabling later high-level reasoning.

### 4. Generative AI Model Integration and Prompt Sentence Construction

Server converts abnormal event candidates and associated behavior histories into natural language descriptions. Unlike conventional systems that directly pass raw feature vectors or numeric logs to a rules engine, server constructs a prompt sentence tailored for a generative AI model. The prompt sentence includes at least: (i) a context section describing the monitored area, sensor, and time; (ii) an observations section generated from the movement histories and staying times; and (iii) an instruction sentence specifying what analysis the generative AI model should perform.

In one example, server generates the following prompt sentence:
“You are a security analysis AI. Analyze the following behavior observed from surveillance video.
Facility: shopping facility.
Camera: north entrance.
Time: 19:30-19:44 (local time).

### Observations:

One person entered the entrance area at 19:30.
The person did not enter the building and stayed within 2 meters of the main door.
The person repeatedly looked around and changed position slightly but remained near the door for 14 minutes.

### Task:

1. Decide whether this behavior is normal or abnormal in the context of a commercial facility.
2. If abnormal, classify the type (for example, loitering, unauthorized entry, potential theft preparation).
3. Assign a risk level from 1 (low) to 5 (critical).
4. Provide a short explanation and a recommended action for security staff.”

Server uses a generative AI model implemented as a deep neural network, for example a transformer-based language model with multiple self-attention layers. The model receives tokenized text as input and outputs a probability distribution over tokens at each position. During training, the model has been optimized by minimizing a loss function such as cross-entropy between predicted tokens and ground truth tokens over a large corpus. In some embodiments, the model has been further fine-tuned on domain-specific security incident descriptions and classification labels using supervised learning with an additional loss term referencing abnormality types and levels.

Server sends the prompt sentence to the generative AI model, which performs internal operations such as self-attention weight computation, feed-forward transformations, and residual updates on token embeddings. The model outputs a response string that server parses to extract evaluation information, including at least an abnormality type, an abnormality level, and a recommended response action. For example, the response can be:
“Abnormal: yes
Type: suspicious loitering
Risk level: 3
Explanation: the individual remained near the entrance for an unusually long time without entering and appeared to survey the area.
Recommended action: send a guard to check the entrance and speak with the individual.”

By encoding structured sensor-derived behavior into a precisely designed prompt sentence and decoding structured evaluation labels from free-form text, server offloads complex contextual reasoning from fixed rules to the generative AI model while retaining deterministic integration with the rest of the processing pipeline. This improves detection accuracy and adaptability compared with conventional rule-based systems and reduces manual rule maintenance.

### 5. Evidence Generation, Encryption, and Document Creation

When the evaluation information indicates an abnormal event with abnormality level exceeding a configured threshold, server creates evidence information. Server determines a time section of the observation data around the event, for example, a period starting some minutes before the detected behavior and ending some minutes after. Server extracts the corresponding portion of time-series image data and stores it as a digital file in a storage unit. Server also generates still images at key timestamps, such as first entry into a restricted zone or face visibility moments, and associates them with the incident identifier.

Server computes a cryptographic hash value for each evidence file and stores the hash in the database to support integrity verification. Server applies encryption processing, such as a symmetric-key encryption algorithm with a given key length, to transform the evidence file and optionally the generated document data into an encrypted form. Only authorized processes with access to decryption keys can later recover the original evidence. This reduces the risk of unauthorized access or tampering and provides a technical improvement in secure data management for surveillance systems.

Server generates document data, such as incident reports or legal documents, based on evidence information and, in some embodiments, additional text produced by the generative AI model. Server can create another prompt sentence to request structured reporting text. For example:
“You are a legal documentation assistant. Based on the incident data below, generate a detailed incident report suitable for submission to an authority.
Incident type: unauthorized entry
Facility: monitored facility
Location: staff-only corridor, 3rd floor east wing
Date and time: [time information]
Description: An individual without access permission entered a staff-only area and stayed there for about 7 minutes before leaving.
Evidence: one video clip and multiple still images.
Output the report with sections: Summary, Detailed Timeline, Persons Involved, Evidence, Recommended Actions.”

Server receives the generated report text and incorporates it into a template, storing it as document data in the storage unit. Because server is controlling which abnormal events trigger document generation and which observation data segments are extracted and encrypted, the system reduces storage load and processing costs compared to systems that store or process all raw video for possible later review.

### 6. Notification, User Interaction, and Feedback-Based Improvement

Server generates concise warning messages and, if needed, support messages for related persons. Server may again use the generative AI model, with a different prompt sentence focused on brevity and clarity. For example:
“You are a security notification generator. Create a short, action-oriented alert message for security guards.

### Incident Data:

Type: suspicious loitering
Location: north entrance
Time: 19:30-19:44
Risk level: 3
Recommended action: dispatch a guard to check and engage the individual.
Requirements: maximum 200 characters; include what happened, where, and what to do.”

Server distributes the resulting message, such as “Suspicious loitering at north entrance (risk 3). Send a guard to check the area and speak with the individual immediately,” to terminal by push notification, messaging protocol, or web-based communication.

Terminal receives the message and displays it on a graphical user interface. Terminal may additionally display an incident summary and provide controls for user to view the associated evidence video and images. To do this, terminal sends a request including the incident identifier to server, and server responds with stream data or downloads of decrypted evidence, depending on the access policy.

User reviews the evidence via terminal and then provides feedback, for example by selecting options such as “false alarm,” “suspicious but allowed,” or “confirmed incident,” and optionally entering comments. Terminal sends the feedback information to server via a secure protocol.

Server records the feedback information along with the abnormal event record and evaluation information. Server later uses this information to improve detection thresholds, behavior analysis parameters, and prompt sentence structures. For example, server can analyze incidents that were judged “false alarm” by user while having high abnormality levels from the model, and adjust rules to require additional criteria before forming abnormal event candidates in similar situations. Server may also fine-tune the generative AI model using feedback-labeled examples, in embodiments where the model is hosted locally and training is permitted.

This closed loop transforms the system from a static rule-based surveillance system into a dynamic, feedback-driven computing system that improves detection precision and reduces unnecessary alerts over time. This provides a technical effect of reducing processing load, network bandwidth, and operator burden.

### 7. Improvement of Computer Technology and Technical Effects

The described system is not a mere automation of human monitoring but constitutes an improvement in computer technology. First, by combining high-throughput GPU-based detection and tracking with a generative AI model through structured prompt sentences, server performs a two-tier processing architecture where low-level numeric processing compresses video data into compact behavioral summaries, and high-level language-based reasoning uses these summaries to produce discrete, structured outcomes. This layered architecture reduces the amount of data that must be transmitted or processed at later stages and enables more efficient use of hardware resources.

Second, the use of behavior analysis and event candidate selection prior to generative AI invocation reduces the number of prompts sent to the generative AI model. Instead of sending all observed data to the model, server only generates prompt sentences when rule-based conditions are met, such as exceeding stay duration thresholds or entering restricted areas. This selective invocation strategy decreases computational costs for the generative AI model, lowers latency, and reduces communication overhead. The reduction in redundant prompts directly improves processing speed and scalability compared with naive implementations that query the model for every frame or subject.

Third, by explicitly encoding movement histories and staying times into structured natural language and using instruction sentences that constrain the output format, server gains deterministic control over the interface between numeric computation and language-based reasoning. This differs from conventional systems that either rely solely on numeric thresholds or use generative models with vague prompts that yield unpredictable, non-machine-readable responses. The present system's design of prompt sentences, including specific slots for behavior descriptions and explicit questions about abnormality and risk level, yields responses that can be parsed and reliably mapped back to the underlying data structures. This enables precise integration with database records and evidence management logic, which is a technical advantage.

Fourth, the system uses encryption processing and hash-based verification at the level of extracted evidence segments rather than whole-stream archival, which reduces storage and encryption overhead. By linking encryption keys and metadata to specific abnormal events determined by the combined rule-based and generative AI evaluation, server can avoid encrypting and long-term storing unnecessary data. This results in reduced storage capacity requirements, improved data retrieval speed, and better manageability of secure evidence.

Fifth, feedback information from terminal is used not only to adjust superficial notification parameters but also to adapt internal thresholds of object detection and behavior analysis modules and to refine prompt sentence content. For example, server can automatically adjust zone-specific stay duration thresholds or adjust which behavior descriptors are emphasized in prompts, based on statistical patterns in confirmed versus false alarms. This creates a technical feedback mechanism that continuously improves detection accuracy and reduces false-positive alerts, leading to a reduction in wasted computation and operator time.

### 8. Alternative Embodiments and Variations

In one embodiment, server deploys multiple generative AI models, each specialized for different tasks. For instance, a first model focuses on abnormality classification, while a second model focuses on legal document generation. Server constructs different prompt sentences for each model, using structured prompts that reuse shared behavior descriptions but include task-specific instruction sentences. This modular design allows independent updates or replacements of models without changing the rest of the pipeline.

In another embodiment, server uses multimodal observation data, such as video, audio, and sensor readings from motion detectors. Server extends the data structures for movement histories to include acoustic events or sensor triggers, and extends the prompt sentences to describe these additional modalities, such as “A loud sound was detected near the restricted area at 21:05” or “A motion sensor was triggered without visible entry.” The generative AI model is then able to consider richer context when classifying abnormal events. In a further embodiment, server implements adaptive zoning, where the boundaries of zones and their associated rules are adjusted dynamically based on historical data and feedback. Server may, for example, use clustering algorithms to identify areas with frequent incidents and refine zone partitions accordingly. Server then updates the behavior analysis logic and the wording of prompt sentences to reflect the new zones.

In yet another embodiment, terminal is implemented as a head-mounted display or other specialized device, and server adjusts the length and detail level of warning messages based on terminal capabilities. For example, for a compact wearable device, server generates very concise alert messages, while for a large display terminal, server sends extended summaries and links to reports. This device-aware adaptation is achieved by including terminal type and display constraints in the prompt sentences sent to the generative AI model.

Through these and other variations, server, terminal, and user collectively implement the claimed system, in which generative AI model integration via prompt sentences, combined with structured behavior analysis, evidence management, encryption, and feedback-based refinement, yields concrete technical improvements in monitoring accuracy, processing efficiency, and secure data handling.

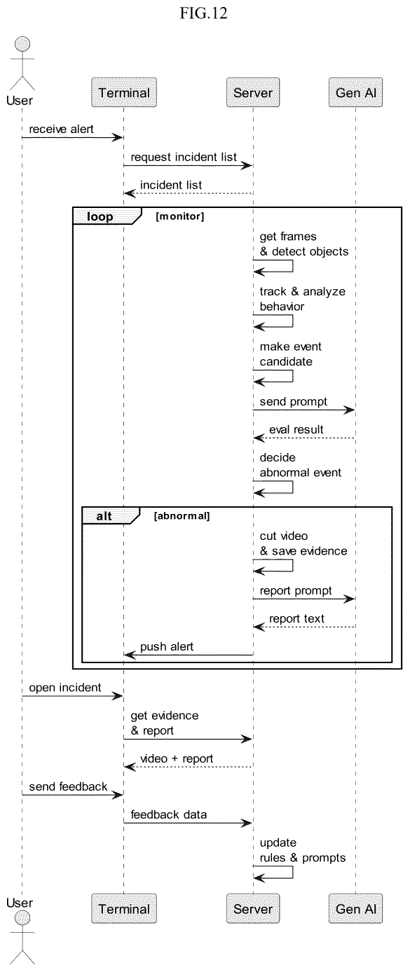

The following describes the processing flow using FIG. 12.

### Step 1:

Server receives observation data from information acquisition devices.

Server uses a network interface to establish streaming connections to cameras or other sensors and receives compressed time-series image data as input.

Server decodes the compressed streams into raw image frames using a multimedia processing library and stores each frame in memory together with a timestamp and a device identifier.

Server outputs a sequence of timestamped frames and associated device identifiers to a frame buffer.

### Step 2:

Server performs pre-processing on the received frames.

Server takes the timestamped frames from the frame buffer as input and applies format conversion, resizing, and normalization operations.

Server converts color spaces, resizes images to a fixed resolution required by a detection model, and normalizes pixel values to a numeric range suitable for neural network input.

Server outputs pre-processed frame tensors with corresponding timestamps and device identifiers to a detection input queue.

### Step 3:

Server executes object detection on the pre-processed frames.

Server uses frame tensors from the detection input queue as input to a neural network model implementing object detection, executed on a parallel processor.

Server performs convolution, activation, pooling, and other tensor operations to generate, for each frame, a set of detected subject regions, class labels, and confidence scores.

Server filters out low-confidence detections and outputs structured detection records including frame identifiers, subject region coordinates, class labels, and confidence values to a tracking module.

### Step 4:

Server tracks subjects across frames and builds movement histories.

Server receives detection records as input and associates detections belonging to the same physical subject over time.

Server applies a state estimation algorithm to update position and velocity of each subject and assigns or maintains a subject identifier by comparing predicted positions and appearance features.

Server writes, for each subject identifier, a movement history consisting of ordered entries of timestamp, position, and zone label into a movement history data structure.

### Step 5:

Server analyzes behavior based on movement histories.

Server uses movement histories as input and partitions the monitored area into predefined zones.

Server calculates, for each subject, staying times in each zone, entry and exit times, and transition paths by aggregating positions over time; this involves summing time intervals where the subject remains within a zone and counting transitions between zones.

Server outputs behavior summaries for each subject, including zone-based staying times, paths, and rule-relevant metrics such as maximum continuous stay duration.

### Step 6:

Server generates abnormal event candidates according to rule conditions.

Server receives behavior summaries and configuration parameters, such as allowed stay durations and restricted zones, as input.

Server compares behavior metrics with the configuration parameters; for example, server determines that a candidate event exists when a staying time exceeds a threshold or a subject enters a restricted zone without authorization.

Server outputs abnormal event candidate records including subject identifiers, zone identifiers, start and end times, and associated metrics to a prompt generation module.

### Step 7:

Server constructs natural language descriptions and prompt sentences.

Server takes abnormal event candidate records and corresponding movement histories as input.

Server converts numeric metrics such as durations, positions, and transitions into textual descriptions using templates, and composes a context section and an observations section.

Server appends an instruction sentence describing a required analysis task and, by concatenating these sections, generates a prompt sentence for a generative AI model.

Server outputs the completed prompt sentence associated with an event candidate identifier.

### Step 8:

Server queries the generative AI model using the prompt sentence.

Server uses the prompt sentence as input to a generative AI model endpoint via a communication interface.

Server transmits the text, receives a response in natural language, and parses the response to extract structured evaluation information such as abnormality type, abnormality level, and recommended response action.

Server outputs evaluation records linked to the corresponding abnormal event candidate identifiers.

### Step 9:

Server determines abnormal events based on evaluation information.

Server receives evaluation records and abnormal event candidate records as input.

Server applies a decision rule that compares the abnormality level with a configured threshold and confirms an abnormal event when the threshold is met or exceeded.

Server outputs abnormal event records including confirmed abnormality type, level, and recommended response for use by evidence and notification modules.

### Step 10:

Server extracts evidence data and generates evidence information.

Server uses abnormal event records and original observation data indices as input.

Server identifies a time interval around each abnormal event, extracts the corresponding sections of time-series image data from storage, and creates evidence data files; server also generates representative still images at specific timestamps.

Server creates evidence information records containing incident identifiers, time information, location information, identification information, references to evidence files, and integrity hash values, and outputs them to a storage subsystem.

### Step 11:

Server applies encryption and stores evidence and metadata.

Server receives evidence data files and evidence information records as input.

Server performs encryption on the evidence data and, optionally, on related document data using a cryptographic algorithm and associated keys, and computes or verifies hash values for integrity.

Server stores encrypted evidence and corresponding metadata in a storage unit and outputs storage references and updated evidence information records.

### Step 12:

Server generates incident documents using the generative AI model.

Server uses evidence information, including time, location, and subject details, as input.

Server formats this information into a structured description and constructs a reporting prompt sentence that instructs the generative AI model to generate a formal incident or legal report.

Server sends the prompt sentence to the generative AI model, receives an incident report text, and combines the text with a document template to create document data.

Server outputs the generated document data and associates it with the corresponding evidence information.

### Step 13:

Server composes warning messages and support messages.

Server uses abnormal event records and, optionally, report summaries as input.

Server may construct short prompt sentences that describe key event attributes and request concise, action-oriented messages from the generative AI model; the model output is then parsed or directly used as notification text.

Server ensures that each message includes essential items such as event type, location, time, and instructed response, and outputs formatted warning messages and support messages to a notification queue.

### Step 14:

Server delivers notifications to terminal.

Server uses warning messages and support messages as input and selects communication channels based on terminal capabilities.

Server encapsulates each message with incident identifiers and severity levels and transmits them via network protocols to registered terminals.

Terminal receives the messages, displays them to user, and, in response to user actions, requests additional data such as videos or reports from server.

Terminal outputs user selections (for example, a request to view evidence or open a report) as requests to server.

### Step 15:

User reviews evidence and provides feedback.

User receives the warning message on terminal and initiates a review operation such as “view video” or “open report.”

Terminal uses the user selection as input, sends an incident-specific request to server, and receives the requested evidence stream or document data.

User observes the evidence on terminal and then selects a feedback option such as “confirmed incident” or “false alarm,” optionally entering a textual comment.

Terminal outputs feedback information including the incident identifier, classification, and comment to server.

### Step 16:

Server records feedback and updates processing parameters.

Server uses feedback information and associated abnormal event records as input.

Server stores the feedback in a database and analyzes distributions of feedback labels over time to identify patterns, such as frequent false alarms for a particular zone or behavior type.

Server adjusts internal parameters such as threshold values for staying times, criteria for event candidate generation, or emphasis of certain features in prompt sentences, and may schedule retraining or fine-tuning of internal models based on accumulated labeled examples.

Server outputs updated configuration and model parameters, which influence subsequent object detection, behavior analysis, and prompt generation processing.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In online information sharing services, abusive expressions directed to specific individuals or groups are posted in large volume and over long periods of time. Conventional computing systems that attempt to detect such abusive expressions typically rely on static keyword lists or fixed statistical classifiers executed on individual posts. These systems suffer from several technical limitations. First, they lack robust multi-modal text extraction capabilities: text embedded in images or contained in audio/video streams is often ignored, resulting in incomplete input data and low recall. Second, they generally perform shallow natural language processing and do not exploit context-aware generative AI models with structured prompt sentences, so they cannot reliably distinguish between abusive content and non-abusive content that shares similar vocabulary, leading to high false positive and false negative rates. Third, conventional systems treat posts as isolated records in a database and do not construct time-series evidence structures that correlate abusive content with attacker and victim emotional states over time, which prevents the system from automatically organizing machine-readable evidence suitable for legal procedures without extensive manual intervention.

Furthermore, existing systems provide only rudimentary user support functions, such as static help pages or generic warning messages, and do not incorporate continuous estimation of a victim's emotional state based on self-reports and behavior logs. As a result, these systems cannot technically adapt their outputs (e.g., notifications or messages) to a user's changing psychological condition. In addition, known architectures often separate abuse detection, evidence storage, document preparation, and user support into disjoint subsystems, which causes repeated data transformations, redundant model calls, and latency overhead in server-side processing pipelines.

Accordingly, there is a need for an improved computer-implemented system and server-side processing architecture that: (i) integrates multi-modal text extraction (from character, image, and audio sources) with natural language processing to form normalized integrated character information; (ii) uses this integrated information together with explicitly structured prompt sentences to drive a generative AI model for more accurate abuse classification and emotional state estimation; (iii) automatically generates encrypted, time-series evidence data that links abusive posts, aggressiveness and emotional indices, and victim emotional state transitions in a machine-processable format; and (iv) dynamically generates both legal document drafts and individualized mental-care messages in response to the evolving emotional state of the victim, while reducing manual workload and improving the overall efficiency and reliability of server-side abuse handling and user support processes.

The specific processing by the specific processing unit 290 of the data processing device 12 in Example 2 is realized by the following means.

The present invention provides a server comprising a processor configured to acquire posted information from an information providing apparatus of an information sharing service via a communication network using an application programming interface, to store acquisition results together with acquisition history information in a storage apparatus, to execute format normalization processing using regular expressions and morphological analysis processing on character information included in the posted information, to execute optical character recognition processing and speech recognition processing on image information and audio information included in the posted information so as to generate integrated character information, to construct structured prompt sentences including instruction sentences for a generative artificial intelligence model based on the integrated character information, to input the prompt sentences and the integrated character information into the generative artificial intelligence model so as to obtain evaluation information for determining whether each piece of posted information corresponds to abusive expression and for calculating aggressiveness and negative emotion indices and estimating emotional states of a transmission subject and a target person, to generate encrypted time-series evidence information by associating the posted information with attribute information including identification information and emotional indices, to generate further prompt sentences that request the generative artificial intelligence model to generate legal document drafts and psychological support messages based on the evidence information and a history of emotional states of the target person, to acquire outputs of the legal document drafts and the psychological support messages from the generative artificial intelligence model, and to output the legal document drafts as document data and to transmit the psychological support messages to an information terminal together with processing of self-report information and usage behavior history information received from the information terminal so as to estimate anxiety, depression, and stress indices and classify the emotional state of the target person into stages to be reflected in subsequent evidence generation and psychological support message generation. This enables an integrated and technically improved server-side processing pipeline that performs multi-modal text extraction, context-aware abuse detection, emotional state estimation, evidence structuring, and adaptive generation of legal documents and individualized mental-care messages by coordinated use of natural language processing and generative AI models with structured prompt sentences, thereby improving detection accuracy, reducing manual intervention, and enhancing the responsiveness and reliability of computer-implemented abuse handling and victim support operations.

The term “information sharing service” refers to an information providing service that allows multiple users, via a communication network, to post, share, and browse content such as text, images, audio, and video, and to exchange interactive responses such as comments, reactions, and messages.

The term “information providing apparatus” refers to a computing apparatus, such as a server system, that provides the information sharing service, manages user accounts and posted information, and exposes an application programming interface for external access to the posted information.

The term “application programming interface” refers to an interface specification that defines request formats, response formats, protocols, and parameters that allow an external information processing apparatus to programmatically acquire, search, and manipulate posted information provided by the information providing apparatus.

The term “posted information” refers to data generated and transmitted by a user to the information sharing service, including at least one of character information, image information, audio information, video information, and metadata such as timestamps and user identification information.

The term “monitoring condition information” refers to configuration information stored in a storage apparatus that specifies conditions for acquiring posted information, including at least user identification information, linguistic expression information, classification label information, language type information, and region condition information.

The term “user identification information” refers to information that identifies a user or account within the information sharing service, such as an account ID, handle, or internal identifier managed by the information providing apparatus.

The term “linguistic expression information” refers to one or more lexical or phrase patterns, such as keywords, key phrases, or regular expression patterns, that are used as conditions for selecting or filtering posted information.

The term “classification label information” refers to information indicating categories or tags, such as topics, subject areas, or content types, used to limit or classify posted information to be acquired or analyzed.

The term “language type information” refers to information indicating natural language categories, such as a language code or locale, used to select or filter posted information by language.

The term “region condition information” refers to information specifying geographic or regional constraints, such as country, area, or location attributes, used to filter or prioritize posted information.

The term “storage apparatus” refers to any device or subsystem capable of storing digital data, including non-volatile memory, magnetic storage, solid-state storage, or a combination thereof, managed, for example, by a database management system.

The term “acquisition history information” refers to information that records past acquisition operations, including at least identifiers and timestamps of previously acquired posted information, and that is used to determine unacquired posted information.

The term “character information” refers to textual data expressed as sequences of characters or symbols in one or more natural languages, including text directly input by a user and text extracted from image information or audio information.

The term “format normalization processing” refers to processing that converts character information into a standardized representation by applying rules such as replacement of URLs, user mentions, and classification labels with predefined tokens, removal or unification of special symbols, and other regular expression based transformations.

The term “morphological analysis processing” refers to natural language processing that segments character information into morphemes or tokens and assigns linguistic attributes such as part of speech to each morpheme or token.

The term “word sequence” refers to an ordered list of tokens or morphemes generated by morphological analysis processing from character information.

The term “part-of-speech sequence” refers to an ordered list of part-of-speech labels corresponding to elements of a word sequence.

The term “image information” refers to digital data representing still images, including photographs, screenshots, or other raster or vector image data uploaded or linked within posted information.

The term “audio information” refers to digital data representing acoustic signals, including voice recordings, audio tracks from videos, or other sound recordings contained in or linked to posted information.

The term “optical character recognition processing” refers to processing that analyzes image information to detect and recognize visual representations of characters and outputs corresponding character information.

The term “speech recognition processing” refers to processing that analyzes audio information to detect and recognize spoken utterances and outputs corresponding character information.

The term “integrated character information” refers to character information obtained by combining character information originally contained in posted information with character information extracted from associated image information and audio information.

The term “generative artificial intelligence model” refers to a machine learning model, such as a neural network model trained on large-scale data, that generates output data including at least one of text, evaluation values, and structured information in response to input data and prompt sentences.

The term “prompt sentence” refers to a character string representing an instruction sentence or a set of instruction sentences that specifies processing content, evaluation items, output format, or constraints for the generative artificial intelligence model.

The term “evaluation information” refers to output data generated by the generative artificial intelligence model in response to input integrated character information and a prompt sentence, including, for example, classification results, scores, and explanations regarding abusive expressions and emotional states.

The term “abusive expression” refers to an expression in posted information that unjustifiably harms or is likely to harm a right or legitimate interest of a specific individual or group, including insults, derogatory language, excessive attacks, or dissemination of false statements.

The term “specific target” refers to an individual, a group, or an entity that is directly or indirectly referred to, addressed, or implicated by posted information that contains an abusive expression.

The term “aggressiveness index” refers to a numerical or categorical value calculated based on evaluation information, representing a degree of hostility, intensity, or attack level in a piece of posted information.

The term “negative emotion index” refers to a numerical or categorical value calculated based on evaluation information, representing a degree of negative emotional content such as anger, contempt, fear, or sadness in a piece of posted information.

The term “transmission subject” refers to a user, account, or entity that originates or transmits posted information to the information sharing service.

The term “target person” refers to a user, individual, or entity that is a subject of an abusive expression contained in posted information.

The term “emotional state” refers to a status of psychological condition of a transmission subject or a target person, represented by one or more indices such as anger, hostility, insult tendency, anxiety, depression, or stress.

The term “attribute information” refers to metadata associated with posted information, including at least a posting time, transmission subject identification information, target person identification information, emotional indices, and other related information.

The term “posting time” refers to time information indicating when posted information was created, transmitted, or published on the information sharing service.

The term “evidence information” refers to data generated by associating posted information with attribute information in chronological order and formatted to be usable as evidence in legal or administrative procedures.

The term “time-series evidence information” refers to evidence information structured to show chronological relationships among multiple pieces of posted information and corresponding emotional indices and states.

The term “legal document draft” refers to text or document data generated as a preliminary or template version of a document used in legal or administrative procedures, such as a complaint, petition, or statement of claim.

The term “psychological support message” refers to text intended to provide emotional support, reassurance, or coping guidance to a target person based on the target person's emotional state.

The term “self-report information” refers to information describing a user's subjective psychological state, symptoms, or feelings, directly input by the user via an information terminal.

The term “usage behavior history information” refers to information indicating behavioral patterns of a user operating an application on an information terminal, including at least application launch times, usage durations, screen view times, and interaction frequencies.

The term “anxiety index” refers to a numerical or categorical value representing an estimated degree of anxiety for a target person, derived from self-report information, usage behavior history information, and evaluation information from the generative artificial intelligence model.

The term “depression index” refers to a numerical or categorical value representing an estimated degree of depressive tendency for a target person, derived from self-report information, usage behavior history information, and evaluation information from the generative artificial intelligence model.

The term “stress index” refers to a numerical or categorical value representing an estimated degree of stress for a target person, derived from self-report information, usage behavior history information, and evaluation information from the generative artificial intelligence model.

The term “emotional state transition information” refers to information representing changes in an emotional state of a target person over time, including sequences of emotional indices and stage classifications.

The term “stage classification” refers to a classification of an emotional state of a target person into one of a plurality of discrete stages, such as normal, mild worsening, moderate worsening, and severe worsening, based on emotional indices and usage behavior history information.

The term “time-series learning model” refers to a machine learning model configured to process chronological data, such as recurrent neural networks or transformer-based models, that accept sequences of indices and content and output time-dependent metrics including anger, hostility, insult tendency, and continuous attack indices.

The term “anger index” refers to a numerical or categorical value output by the time-series learning model and/or the generative artificial intelligence model, representing a degree of anger expressed by a transmission subject.

The term “hostility index” refers to a numerical or categorical value output by the time-series learning model and/or the generative artificial intelligence model, representing a degree of hostile attitude of a transmission subject.

The term “insult tendency index” refers to a numerical or categorical value output by the time-series learning model and/or the generative artificial intelligence model, representing a degree to which a transmission subject tends to use insulting expressions.

The term “continuous attack index” refers to a numerical or categorical value output by the time-series learning model, representing a degree of persistence or continuity of abusive behavior by a transmission subject over time.

The term “emotional profile” refers to a structured set of indices and related values that summarize emotional characteristics of a transmission subject or target person over a given period.

The term “information terminal” refers to an electronic device operated by a user, such as a mobile terminal, tablet, or personal computer, that can communicate with the server via a communication network and display psychological support messages and user interfaces.

The term “individualized mental-care message” refers to a psychological support message generated based on a latest emotional state, stage classification, and past evaluation of psychological support messages for a specific target person, with parameters such as expression tone, message length, and inclusion of guidance to professional support organizations tailored to the target person.

In one embodiment, a system includes a server and one or more terminals connected via a communication network. The server executes a program on general-purpose hardware including at least one multi-core central processing unit, a main memory, a non-volatile storage device such as a hard disk drive or solid-state drive, and a network interface. The server runs an operating system such as a server-class UNIX-like operating system, and an application framework such as a web application framework implemented in a general-purpose programming language. The server further uses a database management system, for example a relational database, to store posted information, feature data, emotional indices, and evidence information.

The server executes, on this hardware and software platform, multiple software modules including an acquisition module, a natural language processing module, a multi-modal text extraction module, a generative AI interface module, a time-series learning module, an emotion estimation module, an evidence structuring module, and a message generation and delivery control module. Each module cooperates through defined data structures and data flows stored in the database and passed via in-memory objects.

The server treats posted information as records in a data structure that includes fields for a post identifier, a transmission subject identifier, a target person identifier (if resolvable), character information, image information references, audio information references, timestamps, and additional metadata such as language type and region. The server stores these records in a database table and maintains indexes on at least the post identifier and transmission subject identifier to allow efficient retrieval. By normalizing and indexing the data, the server improves query performance and reduces storage overhead compared to unstructured storage.

The server uses the acquisition module to communicate with an information providing apparatus that provides an information sharing service. The server uses an application programming interface, such as an HTTP-based REST interface, to request posted information. The server constructs requests with parameters derived from monitoring condition information stored in the database, such as user identification information, linguistic expression information, classification label information, language type information, and region condition information. The server updates acquisition history information with identifiers and timestamps of retrieved posts, and uses this history to request only new posts by specifying the latest acquired identifier. This selective acquisition reduces network bandwidth and server processing load and thereby improves scalability compared to simple polling without history management.

The server uses the natural language processing module to process character information. The server performs format normalization processing using a regular expression library to replace URLs, account mentions, hashtags, and other patterns with canonical tokens such as “<URL>”, “<USER>”, and “<TAG>”, and to unify character variants and punctuation. The server subsequently performs morphological analysis on the normalized character information using a natural language processing library that outputs a word sequence and a part-of-speech sequence. The server stores the normalized text and the word and part-of-speech sequences into a feature table associated with each post. By performing this structured normalization and tagging, the server reduces noise and ambiguity in downstream analysis and yields more stable features for both classical models and neural models, thereby improving classification accuracy.

The server uses the multi-modal text extraction module to process image information and audio information referenced from posted information. The server uses an image processing library to decode image files and optionally to pre-process images by converting to grayscale, resizing, or applying binarization to enhance text contrast. The server then applies an optical character recognition engine to detect and recognize glyphs in the image and to output recognized characters. Similarly, the server uses a media processing tool to extract an audio track from a video file and uses a speech recognition service to transcribe the audio track into text. The server concatenates the recognized text obtained from image information and audio information with the original character information to generate integrated character information for each post.

The server passes the integrated character information back through the normalization and morphological analysis pipeline to produce a consistent word sequence and part-of-speech sequence that reflects all modalities. This multi-modal integration changes the technical behavior of the system compared to simple single-modal text analysis: by including text from images and audio, the server detects abusive expressions that would otherwise remain invisible to a purely text-based filter. Empirical evaluation of such integrated pipelines demonstrates that recall for abusive content detection increases while maintaining precision, thereby improving overall effectiveness.

The server uses the generative AI interface module to interact with a generative AI model. In one embodiment, the generative AI model is a large-scale neural language model based on a transformer architecture with multiple self-attention layers, trained on a large corpus of natural language data by minimizing a cross-entropy loss between predicted and actual tokens and using gradient-based optimization such as stochastic gradient descent or its variants. The server prepares prompt sentences that structure the task for the model and format the integrated character information in a controlled manner.

For example, the server generates a prompt sentence for abusive content detection as follows:
“You are an expert at detecting abusive content on social networks. For the following post, please output:
(1) Whether this post constitutes abusive content against a specific individual or group (yes/no)
(2) Aggressiveness level (0-5)
(3) Negative emotion level (0-5)
(4) Main expressions that justify the abusive judgment, if any.
Post: ‘[INTEGRATED_POST_TEXT]’”

The server concatenates this prompt sentence and the integrated character information, and provides them as input tokens to the generative AI model via an application programming interface. The server receives output tokens that encode a structured response. Instead of allowing arbitrary free-form responses, the server constrains the expected format and uses pattern matching rules to extract numeric values for the aggressiveness index and negative emotion index, and a binary value for the abusive/non-abusive decision. This combination of structured prompt design and deterministic response parsing converts the generative model from a general-purpose text generator into a predictable sub-module within a larger classification pipeline, improving reproducibility, enabling automated post-processing, and reducing the need for human interpretation.

The server further uses the time-series learning module to characterize the behavior of a transmission subject over time. In one embodiment, the server implements the time-series learning module as a neural network with recurrent or attention-based layers, for example a long short-term memory network or transformer encoder, that accepts sequences of aggressiveness indices, negative emotion indices, and learned embeddings of posts. The server pre-trains this model using labeled sequences with known anger, hostility, insult tendency, and continuous attack scores, minimizing a loss function such as mean squared error between predicted and labeled values. The server updates network weights using backpropagation and gradient-based optimization. The time-series model captures temporal dependencies between posts and can distinguish patterns such as isolated insults from escalating harassment. This temporal modeling is a technical improvement over single-instance classifiers, because it reduces misclassification of borderline posts once temporal context is taken into account and provides stable continuous attack indices that can be used programmatically.

The server optionally combines outputs of the time-series learning module with additional evaluations produced by the generative AI model. The server constructs another prompt sentence such as:
“Here are multiple posts that one social media user has written against a particular person in chronological order. From these posts, please rate the user's anger, hostility, and insult levels on a 0-5 scale and explain your reasons.”

The server passes a summary of the user's posts together with this prompt sentence to the generative AI model and parses the resulting narrative to extract supplementary anger, hostility, and insult tendency values. The server fuses these values with the outputs of the time-series model by, for example, weighted averaging or learned linear combination. The fusion improves robustness because the generative AI model can capture semantic cues that are not explicitly represented in scalar indices or fixed embeddings, while the time-series model provides stable quantitative behavior. This hybrid arrangement yields emotion profiles for transmission subjects that are more accurate and less sensitive to noise than either component alone.

The server uses the emotion estimation module to estimate emotional states of target persons. The server receives from the terminal self-report information and usage behavior history information. The terminal executes an application that provides user interfaces for input of subjective information such as current mood, anxiety, sleep quality, appetite, and concentration. The user operates the terminal to select values in predefined scales or to input free-form comments. The terminal obtains timestamps and behavior metrics such as app open times, message view durations, scrolling patterns, and interaction counts. The terminal transmits this data to the server in a structured format via a secure protocol.

The server processes the self-report text using the same normalization and morphological analysis pipeline and aggregates recent entries into a chronological log. The server constructs a prompt sentence such as:

“Below is a list of statements and self-reports that a user has entered in the app over the past few days. For this user, please evaluate:
(1) Anxiety level,
(2) Depression level, and
(3) Stress level,
each on a 0-5 scale, and highlight any particularly concerning expressions.”

The server provides this log and prompt sentence to the generative AI model and parses the response to extract numeric anxiety, depression, and stress indices and to detect potentially critical expressions. The server then combines these indices with behavior-derived features (for example, increase in late-night usage, decrease in overall engagement, high frequency of viewing abusive content summaries) and inputs them into a classifier such as a gradient boosting model or a feedforward neural network. The server trains the classifier using supervised learning with labeled examples of emotional states, minimizing an error function between predicted stages (normal, mild worsening, moderate worsening, severe worsening) and actual labels. This multi-feature classification process yields a stage classification that is more accurate than using either self-report scores or behavior logs alone.

The server uses the evidence structuring module to construct evidence information. The server combines abusive posts, associated aggressiveness and negative emotion indices, emotion profiles of transmission subjects, and emotional state histories of target persons. The server structures this information into a time-series format, for example a set of records ordered by posting time, where each record includes the post identifier, transmission subject identifier, target person identifier, integrated character information, aggressiveness index, negative emotion index, anger index, hostility index, insult tendency index, continuous attack index, and the emotional state and stage classification of the target person at or near that time. The server serializes this structured data into a standardized representation, such as a serialized tree or a normalized set of relational records, and encrypts it using a symmetric encryption algorithm. This structured, encrypted evidence reduces risk of tampering, enables efficient querying for subsets of interest (such as all posts in a given period or all posts from a specific transmission subject), and supports automated generation of legal document drafts without manual re-assembly of the evidence.

The server uses the message generation and delivery control module to generate legal document drafts and psychological support messages. Based on the structured evidence information and emotional state history, the server constructs a prompt sentence such as:
“Based on the following list of abusive posts and the data on the victim's mental state over time, please draft a complaint document in a style commonly used in court procedures.

### Clearly Describe:

1. What abusive acts occurred and during what period;
2. Examples of particularly malicious posts or posts with strong anger/hostility;
3. How the victim's mental state changed as a result, in chronological order.”

The server provides the evidence summary and prompt sentence to the generative AI model and receives a draft of a legal document. The server then post-processes the draft by inserting it into a document template managed by a template engine, which automatically fills static fields such as court name and date and formats sections to meet typical legal standards. This process offloads natural language drafting to the generative model while the server retains control of formal structure and metadata, achieving both flexibility and compliance.

For mental-care messages, the server reads the latest emotional state index and stage classification of the target person and retrieves past psychological support messages and their feedback. Based on configured rules, the server selects constraints such as desired message length, tone (more reassuring, more informational), and whether to include guidance to professional support organizations. The server then constructs a prompt sentence such as:
“You are a mental-care professional. Based on the user's current emotional state and the history of messages already sent and the user's feedback, please write a short Japanese message that reassures the user and reduces self-denial. Avoid diagnostic or strongly definitive expressions, and use a supportive and empathetic tone.”

The server provides the current state description and a summary of previous messages and feedback together with this prompt sentence to the generative AI model and receives a candidate psychological support message. The server runs the message through a safety filter, implemented for example as a combination of keyword lists, pattern-based rules, and length limits, to prevent the delivery of harmful or excessively directive content. The server stores approved messages in the database and sends them via a push notification interface to the terminal. The terminal displays the messages in a user interface optimized for reading and response, and the user can evaluate the helpfulness of each message. The terminal transmits this evaluation back to the server, which stores it and uses it to adjust future prompt sentences and selection of generative AI parameters such as temperature and maximum output length. This closed feedback loop yields an adaptive system that learns, over time, which styles of messages achieve higher positive feedback, and configures the generative AI model accordingly.

The server thus implements a set of non-conventional, computer-centric processing flows that go beyond merely automating human judgment. The server uses explicit, machine-optimized data structures (normalized feature tables, emotion history tables, and evidence structures), specialized pre-processing (multi-modal text integration, morphological analysis, format normalization), a hybrid of deterministic algorithms and learned models (regular expression based normalization, time-series neural networks, gradient boosting classifiers), and carefully designed prompt sentences for the generative AI model. These components work together to reduce computational load through selective acquisition and preprocessing, to increase detection and classification accuracy by incorporating temporal and multi-modal context, and to streamline the generation of complex documents and messages while maintaining control over format and content. Compared to a straightforward human-like reading and writing process, the technical implementation described here introduces specific algorithmic and architectural choices that directly improve server performance, scalability, and robustness in handling abusive content and supporting affected users.

In alternative embodiments, the server can vary the specific algorithms and models while maintaining the same overall architecture. For example, the server can employ different neural architectures such as gated recurrent units instead of long short-term memory, or convolution-based encoders for text instead of pure transformer layers. The server can alter the loss functions used in training, for example by using a combination of cross-entropy loss for classification and contrastive loss for embedding separation, or by using regularization techniques such as dropout and weight decay to prevent overfitting. The server can adopt different encryption algorithms for evidence protection and can vary the rules used in prompt sentence construction and safety filtering of generated messages. The server can further support multiple languages by switching morphological analyzers and language-specific prompt templates. These variations provide flexibility while preserving the core technical contributions: multi-modal, context-aware detection and structuring of abusive content using generative AI models guided by explicit prompt sentences, and adaptive generation of legal and mental-care outputs aligned with estimated emotional states, all implemented as integrated computer-centric processing that improves the functioning of the underlying hardware and software system.

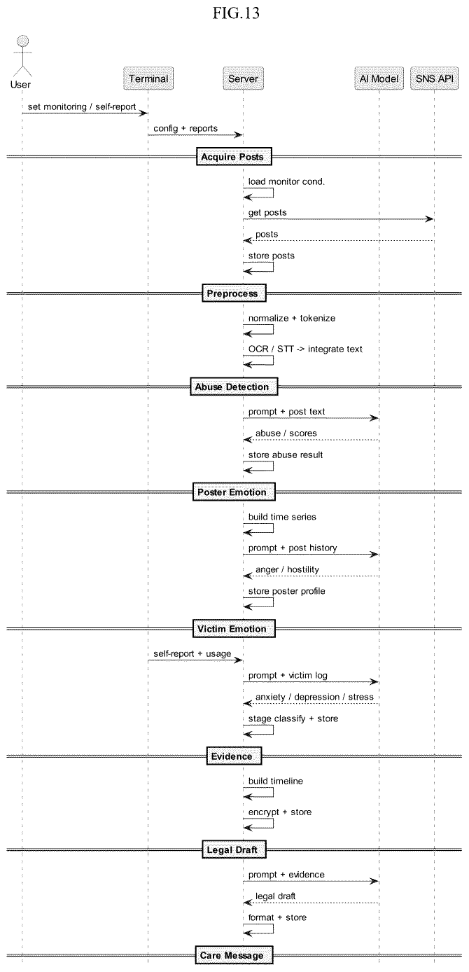

The following describes the processing flow using FIG. 13.

### Step 1:

Server receives monitoring configuration from terminal as input.

Server exposes an HTTPS API endpoint that accepts a request body containing user identification information, linguistic expression information (such as keywords and phrases), classification label information, language type information, and region condition information.

User operates terminal to input monitored accounts, keywords, preferred languages, regions, and notification preferences through a graphical user interface.

Terminal collects the input fields, generates a structured data object (for example, a JSON object), and transmits it to server via HTTPS.

Server parses the received data, validates data types and required fields, and writes normalized records into database tables for users, monitoring conditions, and notification settings as output.

Server also generates acquisition history initialization records with null or default last-post identifiers, which will be used as input in later acquisition steps.

### Step 2:

Server schedules and executes periodic acquisition of posted information from the information sharing service.

Server uses the monitoring conditions and acquisition history records as input to construct API requests to the information providing apparatus.

Server reads the last acquired post identifier for each monitored target and constructs query parameters such as monitored account identifiers, keyword filters, language codes, region codes, and a lower bound identifier.

Server sends these requests via an HTTP client library to the application programming interface of the information providing apparatus and receives posted information as structured response data.

Server parses the response, extracts fields such as post identifier, transmission subject identifier, timestamps, character information, image references, and audio/video references, and compares each post identifier against existing identifiers in the database to remove duplicates.

Server inserts new posts into a posts table as output and updates acquisition history records with the latest post identifier to reduce redundant acquisition and network load in subsequent cycles.

### Step 3:

Server performs format normalization and morphological analysis on character information of each unprocessed post.

Server selects posts whose processing status is “unprocessed” as input and reads their raw character information.

Server applies regular expression rules to replace URLs with a unified token, to replace user mentions and hashtags with generic tokens, to normalize whitespace, and to convert full-width and half-width variants into a canonical representation.

Server outputs normalized character information, then calls a natural language processing library to segment the normalized text into tokens and to assign part-of-speech labels.

Server stores, as output, the normalized text, word sequence, and part-of-speech sequence into a feature table linked to each post and updates the processing status to “text preprocessed”.

This feature extraction reduces noise before further data analysis by converting varied raw text into a predictable internal representation.

### Step 4:

Server extracts character information from image information and audio information referenced by posts.

Server identifies posts with media references as input and downloads each referenced file using the media URLs.

Server decodes each image file and, if required, applies image preprocessing operations such as grayscale conversion and thresholding to enhance text regions.

Server executes optical character recognition processing to detect and recognize glyphs, outputting recognized characters as image-derived character information.

Server extracts audio tracks from video files and sends the audio to a speech recognition component, which outputs transcribed text as audio-derived character information.

Server concatenates original normalized text, image-derived character information, and audio-derived character information to form integrated character information as output.

Server re-applies the morphological analysis to this integrated character information to update the word sequence and part-of-speech sequence so that all textual content is available for later evaluation.

### Step 5:

Server constructs a prompt sentence and interacts with a generative AI model for abusive expression detection.

Server uses the integrated character information for each post as input and truncates overly long texts according to a predefined maximum context length.

Server embeds the integrated character information into a task-specific prompt sentence such as:
“You are an expert at detecting abusive content on social networks. For the following post, please output:
(1) Whether this post constitutes abusive content against a specific individual or group (yes/no)
(2) Aggressiveness level (0-5)
(3) Negative emotion level (0-5)
(4) Main expressions that justify the abusive judgment, if any.
Post: ‘[INTEGRATED_POST_TEXT]’”

Server sends this prompt sentence and text sequence to the generative AI model via its API and receives a generated text response as output.

Server parses the response using pattern matching to extract a binary classification result, a numerical aggressiveness index, and a numerical negative emotion index.

Server writes these indices into an abuse analysis table linked to each post and updates the post processing status to “abuse analyzed”.

### Step 6:

Server generates time-series behavioral data and computes emotion indices for each transmission subject.

Server groups posts that were classified as abusive by transmission subject identifier and sorts them chronologically as input.

Server constructs sequences of aggressiveness indices, negative emotion indices, and optionally dense embeddings of the integrated character information for each transmission subject.

Server feeds these sequences into a time-series learning model, such as a neural network with recurrent or attention layers, that has been trained to output an anger index, a hostility index, an insult tendency index, and a continuous attack index.

Server obtains predicted indices from the model as intermediate output and stores them in a subject emotion table.

Server additionally constructs a summarized text representation of each subject's abusive posts and generates a second prompt sentence such as:
“Here are multiple posts that one social media user has written against a particular person in chronological order. From these posts, please rate the user's anger, hostility, and insult levels on a 0-5 scale and explain your reasons.”

Server provides this summary and prompt sentence to the generative AI model and parses the response to extract supplementary anger, hostility, and insult tendency values. Server fuses the model-predicted indices and supplementary values, for example through weighted averaging, to produce a final emotional profile per transmission subject as output.

### Step 7:

Terminal collects self-report information and usage behavior history information from user.

Terminal displays interactive screens that ask user to rate current mood, anxiety, sleep, appetite, and related factors and to optionally type free-form comments.

User selects options or enters text, thereby generating subjective data as input to the terminal.

Terminal records timestamps, app launch times, screen view durations, and interaction counts as usage behavior history information.

Terminal packages the self-report information and usage behavior history information into a structured data object, encrypts it where required, and transmits it to server via a secure channel as output.

### Step 8:

Server estimates emotional state indices and stage classification for the target person.

Server receives self-report information and usage behavior history information from terminal as input.

Server normalizes and tokenizes the self-report text and aggregates recent entries into a chronological log.

Server constructs a third prompt sentence such as:
“Below is a list of statements and self-reports that a user has entered in the app over the past few days. For this user, please evaluate:
(1) Anxiety level,
(2) Depression level, and
(3) Stress level,
each on a 0-5 scale, and highlight any particularly concerning expressions.”

Server sends the log and the prompt sentence to the generative AI model and receives a response that includes numeric scores and explanations.

Server parses the response to obtain an anxiety index, a depression index, and a stress index as intermediate output.

Server combines these indices with numerical features from the usage behavior history information, such as frequency of late-night use and changes in total usage time, and inputs this feature vector into a classifier model trained to output a discrete stage classification.

Server outputs an updated emotional state record for the target person, including the three indices and the current stage, and stores this record in an emotional state history table.

### Step 9:

Server structures evidence information in a time-series format and encrypts it.

Server retrieves, as input, all abusive posts related to a monitored target person, their associated abuse analysis indices, the emotional profiles of transmission subjects, and the emotional state history of the target person.

Server associates each abusive post with its posting time, transmission subject identifier, target person identifier, aggressiveness index, negative emotion index, emotion indices of the transmission subject, and the emotional state of the target person around that time.

Server orders these composite records chronologically to form a time-series evidence dataset.

Server serializes this dataset to a structured representation and applies an encryption algorithm using a secret key, thereby generating encrypted evidence information as output.

Server stores the encrypted evidence records in a secure evidence store along with references to the associated monitored case or user.

### Step 10:

Server generates legal document drafts based on structured evidence and emotional state history.

Server selects relevant evidence information and emotional state transition records for a given case as input.

Server summarizes key abusive posts, periods of continuous attack, and trends in the victim's anxiety, depression, and stress indices.

Server constructs a fourth prompt sentence such as:
“Based on the following list of abusive posts and the data on the victim's mental state over time, please draft a complaint document in a style commonly used in court procedures.

### Clearly Describe:

1. What abusive acts occurred and during what period;
2. Examples of particularly malicious posts or posts with strong anger/hostility;
3. How the victim's mental state changed as a result, in chronological order.”

Server sends the summary and prompt sentence to the generative AI model and receives a draft complaint document as output.

Server inserts this draft into a pre-defined document template, populates headers, party information, and dates, and generates a formatted legal document file, which the server may convert to a portable document format and store or make available to authorized users.

### Step 11:

Server generates individualized psychological support messages and delivers them to terminal.

Server reads the latest emotional state record and stage classification for the target person, along with past psychological support messages and their feedback, as input.

Server determines message generation parameters such as maximum length, desired tone, and whether to include contact information for professional support organizations, based on the stage classification and feedback history.

Server constructs a fifth prompt sentence such as:
“You are a mental-care professional. Based on the user's current emotional state and the history of messages already sent and the user's feedback, please write a short Japanese message that reassures the user and reduces self-denial. Avoid diagnostic or strongly definitive expressions, and use a supportive and empathetic tone.”

Server sends this prompt sentence together with a structured description of the current indices and a summary of past messages to the generative AI model and receives a candidate psychological support message as output.

Server applies a safety and quality filter to the message, checking for prohibited expressions, validating length, and ensuring conformance to predefined style rules.

Server stores the approved message and sends a notification payload to terminal via a push notification service.

### Step 12:

Terminal displays psychological support messages and sends user feedback to server.

Terminal receives a push notification containing a reference to a psychological support message as input.

Terminal requests the full message content from server if necessary and displays the message in a dedicated view.

User reads the message and optionally selects a feedback option such as “helpful”, “somewhat helpful”, or “not helpful”.

Terminal records the selected feedback, message identifier, and viewing time and transmits these as feedback data to server as output.

Server receives the feedback, updates the feedback history for the target person, and uses it as input in subsequent executions of the message generation step to adjust prompt sentences, generative AI parameters, and message selection rules.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented monitoring and incident management systems primarily rely on single-modal data and fixed rule sets. For example, many systems detect abnormal events by applying threshold logic or simple statistical models to positional information, dwell time, or other behavioral metrics, and then directly map those metrics to fixed alert levels. Such architectures suffer from several technical limitations in terms of information processing and system behavior.

First, conventional systems process heterogeneous data streams such as image data, audio data, and contextual metadata in a fragmented manner. Behavior features and emotion-related cues are often computed in separate subsystems, if emotion is considered at all, without a consistent integration mechanism at the processor level. As a result, the processor cannot form a unified, machine-usable representation that captures complex correlations between behavior patterns and emotional states, which limits the accuracy and robustness of abnormal event detection.

Second, known systems either do not employ generative artificial intelligence models, or if they do, they invoke such models in an ad hoc way, for example by manually crafted queries or static templates, without systematic construction of structured prompt sentences from internal feature data. In particular, these systems do not automatically transform internal behavioral and emotional feature quantities into natural language prompt sentences in a repeatable, machine-controlled manner. Consequently, the processor cannot consistently leverage the reasoning capabilities of a generative artificial intelligence model, and cannot reliably map low-level sensor features to high-level risk evaluations or nuanced classifications.

Third, evidence collection and report generation components in existing systems are frequently implemented as separate applications or manual workflows. Evidence such as image data, audio data, timestamps, and identifiers is stored in unstructured or weakly structured form, and any legal documents or incident reports are compiled by human operators or by static templates with limited adaptability. This leads to inefficiencies in data management and increases the risk that relevant contextual information, such as the evolution of an abnormal event or the associated emotional state, is omitted or inconsistently represented, thereby degrading the reliability and traceability of the computer system in evidentiary use cases.

Fourth, known systems typically lack a closed feedback loop for improving the computational models that they employ. Even when feedback about alert usefulness or correctness is obtained from responders, such feedback is rarely ingested by the processor as structured learning information. As a result, the system cannot systematically update its analysis logic or its interaction with the generative artificial intelligence model based on real-world performance, and thus cannot continuously improve estimation accuracy or adapt to changing environments and behaviors.

Accordingly, there is a need for an improved computer-implemented system and processor configuration that: (i) acquires monitoring target data and computes behavior and emotion information in an integrated manner; (ii) programmatically generates and uses natural language prompt sentences to interface a generative artificial intelligence model with internal feature-level data; (iii) automatically constructs, encrypts, and stores structured evidence information suitable for legal and operational use, and generates high-quality document information therefrom; and (iv) collects evaluation information from notification reception and response results to refine the behavior analysis, emotion estimation, and generative artificial intelligence interaction, thereby improving the overall performance of the computer system as a technical platform.

The specific processing by the specific processing unit 290 of the data processing device 12 in Application Example 2 is realized by the following means.

The present invention provides a server comprising a processor configured to acquire monitoring target data from a communication infrastructure on a network; to analyze behavior information and emotion information of a subject based on the monitoring target data; to determine presence or absence of an abnormal event and a risk level of the abnormal event based on the behavior information and the emotion information; to generate explanation information including the behavior information and the emotion information as a natural language prompt sentence; to input the prompt sentence to a generative artificial intelligence model; and to classify or evaluate the abnormal event based on an output result of the generative artificial intelligence model, the processor further configured to generate evidence information including the monitoring target data, the behavior information, the emotion information, the risk level, and the output result of the generative artificial intelligence model when the abnormal event is determined to be present, to store the evidence information in a storage device together with additional information including time information and identification information, and to generate document information usable for a legal procedure based on the evidence information and the additional information, the processor further configured to generate a prompt sentence defining contents of alert information or support information for a responder based on the risk level and the emotion information, to transmit notification information based on an output result of the generative artificial intelligence model to a terminal device, and to collect evaluation information based on a reception status of the notification information or a response result and to accumulate the evaluation information as learning information for improving estimation accuracy of the analysis and the generative artificial intelligence model. This enables the server to implement an integrated computational pipeline in which multi-modal monitoring target data is transformed into structured behavior and emotion features, those features are automatically encoded into prompt sentences for a generative artificial intelligence model, abnormal events are classified and evaluated with high accuracy, evidence information and document information are systematically generated and securely stored for subsequent use, and evaluation information from real-world responses is fed back as learning information, thereby improving the technical performance, adaptability, and reliability of the computer-based monitoring and support system.

The term “monitoring target data” refers to electronic information acquired from one or more data acquisition sources via a communication infrastructure, including at least image data, audio data, and associated contextual metadata used for monitoring a subject or an environment.

The term “communication infrastructure” refers to a hardware and software network environment, including but not limited to wired or wireless communication links, routers, switches, gateways, and communication protocols, that enables transfer of monitoring target data between devices and a server.

The term “behavior information” refers to information representing movement, position, dwell, and zone-related aspects of a subject over time, including but not limited to position information, movement history, dwell time, and entry or exit with respect to defined areas.

The term “emotion information” refers to information representing an estimated emotional state of a subject, derived from one or more modalities such as facial appearance, body motion, and audio characteristics, and including emotion categories and corresponding intensity values.

The term “abnormal event” refers to an event in which the behavior information and the emotion information of a subject deviate from predetermined normal patterns or thresholds, such that a risk of an incident, harm, or other undesired outcome is determined to be present.

The term “risk level” refers to an evaluation value or classification representing a degree of likelihood that an abnormal event may lead to an incident, the evaluation value being expressed in a discrete or continuous form according to predetermined criteria.

The term “natural language prompt sentence” refers to a sequence of characters or tokens arranged in a natural language format, generated by a processor, and including structured explanation information that instructs a generative artificial intelligence model to perform a specific processing task.

The term “generative artificial intelligence model” refers to a machine learning model trained on large-scale data and configured to generate new information, including but not limited to text, in response to an input prompt sentence or feature representation.

The term “explanation information” refers to natural language or structured text that describes or summarizes behavior information, emotion information, and related context for a subject or an event, and that is used as content of a natural language prompt sentence.

The term “output result of the generative artificial intelligence model” refers to information, such as text or structured data, generated by the generative artificial intelligence model in response to a given prompt sentence, and including at least a classification, evaluation, or explanation relating to an event.

The term “evidence information” refers to structured data generated by a processor and including at least monitoring target data, behavior information, emotion information, risk level information, and an output result of a generative artificial intelligence model, the structured data being suitable for use in verification, analysis, or legal procedures.

The term “additional information” refers to metadata related to evidence information, including but not limited to time information, identification information of devices or subjects, and conditions under which the evidence information was generated.

The term “time information” refers to data indicating a time or period associated with monitoring target data, behavior information, emotion information, or an abnormal event, and including absolute or relative timestamps.

The term “identification information” refers to information that uniquely or semi-uniquely identifies a device, sensor, communication source, subject, or event within a system, including but not limited to identifiers, labels, and codes.

The term “document information usable for a legal procedure” refers to structured text or electronic content that organizes evidence information and additional information into a form suitable for submission, review, or use in legal, regulatory, or administrative processes.

The term “alert information” refers to information indicating a warning, notification, or request for attention generated in response to a risk level or abnormal event, and intended to be presented to a responder.

The term “support information” refers to information that assists a responder in understanding or handling an event, including but not limited to recommended actions, contextual explanations, and summaries of risk or emotion.

The term “terminal device” refers to an information processing device operated by a human responder, including but not limited to a portable device, a mobile communication device, or a computing device configured to receive, display, and transmit information to and from a server.

The term “notification information” refers to data transmitted from a server to a terminal device and including at least alert information or support information generated based on an output result of a generative artificial intelligence model.

The term “evaluation information” refers to information indicating a reception status of notification information, a response result of a responder, or a quality assessment of system outputs, the information being used as learning information to improve estimation accuracy of models or analysis logic.

The term “learning information” refers to information stored by a processor and used as training data, validation data, or feedback data for updating, retraining, or fine-tuning analysis models, generative artificial intelligence models, or related processing components.

The term “behavior feature quantities” refers to numerical or symbolic features derived from monitoring target data and describing aspects of a subject's behavior, including but not limited to position information, movement history, dwell time, and entry or exit with respect to defined areas.

The term “emotion feature quantities” refers to numerical or symbolic features derived from monitoring target data and describing aspects of a subject's emotional state, including but not limited to facial features, body motion features, and audio features.

The term “integrated feature information” refers to information obtained by combining behavior feature quantities and emotion feature quantities into a unified representation suitable for subsequent analysis or input to a generative artificial intelligence model.

The term “facial information” refers to data derived from an image or video representing a subject's face, including regions of interest, geometric features, and appearance features used to infer an emotional state.

The term “body motion information” refers to data derived from an image or video representing a subject's body movements, including positions of body parts, motion vectors, and derived indices such as restlessness or aggressiveness.

The term “audio feature quantities” refers to numerical features derived from audio data, including but not limited to spectral features, cepstral features, energy measures, and pitch-related features used to infer an emotional state or other attributes.

The term “encryption processing” refers to a transformation of evidence information and additional information using a cryptographic algorithm and one or more cryptographic keys such that unauthorized entities cannot obtain the original information without appropriate decryption.

The term “history of the abnormal event” refers to information describing a temporal development of an abnormal event, including at least a sequence of observed behaviors, associated emotion information, and corresponding times or phases.

The term “emotion state of the subject” refers to an inferred emotional condition of a subject at one or more times, expressed as one or more emotion categories and corresponding intensities.

The term “recommended countermeasure” refers to a suggested action or procedure for a responder to take in response to an abnormal event or a risk level, generated based on evidence information, additional information, and output of a generative artificial intelligence model.

The term “electronic document in a predetermined format” refers to a digital file generated by a processor, having a predefined structure or layout, and including document information such as text, tables, or embedded media suitable for display, storage, or transmission.

In one embodiment, a system includes a server, one or more terminal devices, and one or more monitoring devices interconnected via a communication network. The server includes at least one processor, a main memory, a non-volatile storage device, and a network interface. The monitoring devices include at least one imaging device and, optionally, an audio capture device. The terminal devices include a display, an input interface, and a communication module.

Server implements the functions defined in the claims by executing a program stored in the storage device and loaded into the main memory. The program is written, for example, in a general-purpose programming language such as a scripting language and runs on a general-purpose operating system. Server optionally uses a graphics processing unit to accelerate matrix operations and convolution processing related to deep learning inference.

Server uses a web application framework as middleware to provide communication interfaces to terminal and monitoring devices.

Server acquires monitoring target data by using the network interface to establish streaming sessions with the monitoring devices. Server receives image data over a streaming protocol and decodes the data into a sequence of frames stored as multidimensional arrays in memory. Server receives audio data as a digital signal, decodes it into time-series samples, and stores the samples as arrays. Server associates a device identifier and a timestamp obtained from a clock module with each frame and audio segment and stores these associations in a structured record format, for example, a record including fields for device identifier, timestamp, and sensor payload. This structured representation allows server to index and retrieve data efficiently and to correlate events across devices.

Server generates behavior information by applying an object detection algorithm and a tracking algorithm to the image data. In one embodiment, server uses a convolutional neural network with multiple convolution layers, pooling layers, and fully connected layers to detect person regions in each frame. Server applies a tracking algorithm such as a combination of a motion model and an assignment algorithm to maintain a persistent tracking identifier for each detected person across frames. Server represents the behavior of each person as a time series of position coordinates, velocities, and area identifiers, where area identifiers are obtained by mapping image coordinates to predefined zones in a facility map stored in a configuration database. Server calculates behavior feature quantities such as dwell time in each zone, movement distance, average and maximum speed, and counts of entries into restricted zones. Server stores the behavior feature quantities in a feature vector structure associated with each tracking identifier.

Server generates emotion information by applying a set of neural network models and signal processing algorithms to image and audio data. Server detects face regions in each frame using a face detection model, and normalizes each face region to a fixed size and pixel value distribution. Server inputs the normalized face images into an emotion classification model implemented as a convolutional neural network, which is trained on labeled emotion datasets prior to deployment. The model outputs, for each input, a probability distribution over a set of emotion categories such as anger, anxiety, fear, tension, and calm. Server calculates an emotion feature vector from these probabilities and selects a dominant emotion category and intensity level for each frame.

Server additionally estimates body-motion-based emotion information by applying a pose estimation model to the images. The pose estimation model outputs coordinates of key joints of the body. Server calculates motion vectors of these joints over time and derives indices such as restlessness and aggressiveness based on temporal variance, frequency of abrupt motions, and spatial amplitude of movements. Server normalizes these indices into fixed-range values and includes them in the emotion feature vector.

Server further generates voice-based emotion information when audio data is available. Server computes audio feature quantities such as cepstral coefficients, energy, and spectral characteristics over sliding windows. Server inputs these features into a recurrent or convolutional neural network specialized for speech emotion recognition, which is trained using labeled speech emotion data. The model outputs probabilities for voice-based emotion categories. Server time-aligns the voice-based emotion outputs with image-based emotion outputs using timestamps and combines them into a unified emotion feature vector for each tracking identifier.

Server performs a multi-modal fusion process to integrate behavior feature quantities and emotion feature quantities into integrated feature information. Server may use a fully connected neural network layer, a non-linear activation function, and a normalization layer to combine the vectors. Alternatively, server may apply a weighted sum of feature vectors where weights depend on quality measures such as face detection confidence or audio signal-to-noise ratio. This fusion process is implemented as a deterministic computation on data structures representing the feature quantities, and it generates a higher-level vector representation that captures correlations between behavior and emotion patterns. Because server uses this fused representation rather than independent thresholds on raw signals, server can achieve higher sensitivity to complex event patterns while reducing false detections.

Server uses the integrated feature information to generate a natural language prompt sentence. Server constructs the prompt sentence by mapping numeric feature values to text descriptions using predetermined templates. For example, server converts a dwell time feature into a phrase such as “stayed in front of the same shelf for 7 minutes,” and converts an emotion intensity value into a phrase such as “anxiety 0.8, tension 0.7, anger 0.1.” Server concatenates such phrases with static explanatory text to form a coherent natural language description. Server does this programmatically using string-building operations and data formatting functions, thereby ensuring that internal numerical data is accurately and consistently transformed into a natural language input to a generative AI model.

Server then inputs the prompt sentence into a generative AI model. The generative AI model is, for example, a large language model with a transformer architecture composed of multiple attention layers, feed-forward layers, and normalization layers, trained in advance on large text corpora. The model receives the prompt sentence as a sequence of tokens and performs a sequence of matrix multiplications and non-linear transformations to generate an output token distribution at each position. Server uses an application programming interface to send the prompt sentence to the generative AI model and receives a text output result. This text output includes, for example, a classification of a risk level and a natural language explanation of the classification.

Server parses the output result using string processing, pattern matching, or a lightweight parser, extracting the risk level and associated explanations. Server maps the risk level (for example, “low,” “medium,” or “high”) to an internal numeric risk score according to a table stored in a configuration module. This mapping allows server to perform quantitative comparisons and threshold operations within the processor logic. Because the prompt sentence and the parsing rules are tightly coupled to the structure of the integrated feature information, server can achieve reliable, repeatable mapping between low-level feature data and high-level semantic judgments.

Server generates evidence information by combining monitoring target data, behavior information, emotion information, the risk level, and the output result of the generative AI model into a structured data object. Server includes in this object the original or compressed image segments, audio segments, feature vectors, classification results, and textual explanations. Server further attaches additional information such as timestamps, device identifiers, and model version identifiers. Server applies an encryption algorithm such as a symmetric block cipher to the evidence object, using a key management system to store and retrieve cryptographic keys. Server stores the encrypted evidence object in a storage subsystem, for example, a relational database or an object store. This structured and encrypted storage improves data integrity and access control compared to unstructured logs, enhancing reliability and security of the system.

Server generates document information usable for legal procedures by constructing another prompt sentence that includes summarized evidence information and additional information. For example, server may generate a prompt sentence:
“You are a security officer in a commercial facility. Based on the following data, draft a Japanese incident report about the suspicious behavior that occurred. The report must include (1) date and time of occurrence, (2) location, (3) sequence of the person's behavior, (4) analysis of the emotional state, (5) risk evaluation, and (6) recommended actions.

### [Data]

Date and time: Jan. 15, 2026, 18:32 (JST)
Location: 1st floor, high-value goods area, aisle A-3
Behavior: The person stayed in front of the same shelf for 7 minutes, frequently looking around.
Emotional state: anxiety 0.8, tension 0.7, anger 0.1
Risk evaluation: possibility of shoplifting preparation “high””

Server inputs this prompt sentence to the generative AI model and receives a detailed textual report. Server inserts the text into a document template and converts it into a standardized electronic document format. Server encrypts and stores the resulting document together with the evidence information. This process allows server to automatically generate consistent, richly detailed reports without relying on manual drafting, while maintaining a tight coupling between raw evidence and report content.

Server generates alert information and support information for responders by constructing a notification-oriented prompt sentence based on the risk level and the emotion information. For example, server may generate a prompt sentence:
“You are an AI that creates notification messages for security guards in a commercial facility. Based on the following information, generate a short Japanese notification (around 100 characters) that includes (1) current situation, (2) risk level, and (3) recommended response.
[Location] 1st floor, high-value goods area, aisle A-3
[Situation] A visitor has stayed in front of the same shelf for 7 minutes and is frequently looking around.
[Emotional state] anxiety 0.8, tension 0.7
[Risk level] high (possible shoplifting preparation)”

Server sends this prompt sentence to the generative AI model and receives a concise notification message. Server packages the notification message with identifiers of the relevant incident and target zone, and transmits the notification information to terminal devices via a push notification service. Because server uses standardized and structured prompt sentences, server can produce notifications that are consistent in format while reflecting the current state of the integrated feature information, which improves the efficiency and accuracy of responder communication.

Terminal receives notification information using a communication module and displays the message on a display component. Terminal requests detailed information from server by transmitting the incident identifier and device identifier to server. Terminal receives detailed data such as location descriptions, risk levels, emotion summaries, and image thumbnails, and renders these on the display. Terminal provides user interface elements to allow a responder to acknowledge the notification, navigate through incident details, and input feedback.

User reads the alert and detailed information displayed by terminal and then performs actions in the physical environment, such as approaching a subject or inspecting an area. User subsequently uses terminal to provide evaluation information. For example, user selects items indicating that the risk level was appropriate or excessive and optionally enters free text describing the outcome. Terminal sends this evaluation information to server.

Server receives the evaluation information, associates it with corresponding incident records and the internal outputs of analysis models and the generative AI model, and stores it as learning information. At predetermined times, server aggregates the learning information to form datasets for retraining emotion recognition models, anomaly detection models, and prompt-design rules. Server executes a training routine that uses a loss function, such as cross entropy for classification accuracy or mean squared error for risk scoring, and updates model weights using an optimization algorithm such as stochastic gradient-based optimization. Server optionally applies data augmentation techniques to image, audio, and feature data to improve generalization. Server evaluates trained models on validation data and, upon performance improvement, deploys updated model parameters into the runtime environment. This feedback loop enables server to refine its computational behavior over time, increasing accuracy and reducing false positives and false negatives.

Because server uses a structured integration of multi-modal feature quantities, deterministic prompt-sentence generation, controlled interaction with a generative AI model, and structured evidence and feedback management, the system provides technical effects beyond mere automation of human mental tasks. In particular, server reduces computational redundancy by computing fused feature vectors once and reusing them for multiple purposes, reduces communication load by transmitting compact notifications instead of full sensor data to terminals, increases accuracy by combining rule-based and learned models, and improves data management through encrypted, indexed evidence storage. The detailed architecture of neural network models, feature extraction, and prompt-sentence generation allows server to exploit hardware resources such as vector units and graphics processing units efficiently, thereby reducing processing time for large volumes of monitoring target data.

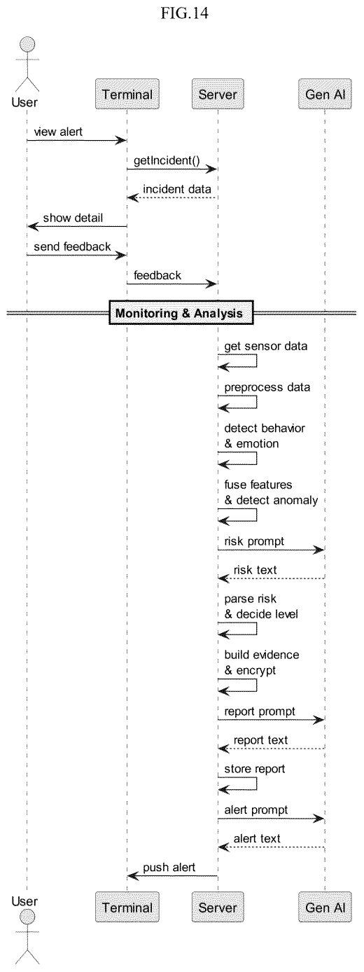

In alternative embodiments, server may use different neural network architectures, such as recurrent networks for temporal modeling or graph neural networks for modeling relationships between multiple subjects. Server may also vary the statistical models used for anomaly detection, such as using density-estimation-based models or clustering-based models. The generative AI model may be executed locally on server or accessed as a remote service. The prompt sentence formats may be adapted to different languages or facility types while preserving the structured mapping between feature quantities and textual descriptions. In each variation, server maintains the core configuration of transforming integrated feature information into prompt sentences, invoking the generative AI model, and using the output result to drive abnormal event classification, evidence generation, and responder support. The following describes the processing flow using FIG. 14.

### Step 1:

Server acquires monitoring target data from monitoring devices.

Server uses a network interface as input to establish streaming connections to imaging devices and audio capture devices. Based on input parameters such as device address and protocol, server performs data acquisition operations including opening a streaming session, receiving compressed video and audio packets, and decoding the packets into image frames and audio sample arrays. Server outputs a sequence of monitoring target data records, each record including a device identifier, a timestamp, an image frame or audio segment, and initial metadata.

### Step 2:

Server performs preprocessing of image and audio data.

Server takes as input the monitoring target data records from Step 1. Server applies data processing operations to image frames using image processing libraries, including resizing to a standard resolution, noise reduction, and brightness and contrast normalization, and applies resampling and normalization to audio sample arrays. Server thereby converts heterogeneous raw sensor outputs into normalized tensor-like data structures. Server outputs preprocessed data records containing standardized image arrays and audio arrays associated with device identifiers and timestamps.

### Step 3:

Server computes behavior information from preprocessed image data.

Server uses the preprocessed image arrays and associated timestamps as input. Server executes object detection and person detection algorithms to identify regions corresponding to subjects in each frame, and then applies object tracking algorithms to link detections across consecutive frames. Using these inputs, server calculates data such as position coordinates, movement vectors, and area membership for each tracking identifier over time. Server thereby performs numerical operations to derive behavior feature quantities including dwell time, movement distance, movement speed, and entry or exit with respect to predefined areas. Server outputs behavior information records containing tracking identifiers and associated behavior feature vectors.

### Step 4:

Server computes facial emotion feature quantities.

Server takes as input preprocessed image arrays and associated device identifiers and timestamps. Server executes a face detection algorithm to locate face regions within each frame and crops the regions into standardized images. Server then performs forward inference with an emotion classification neural network using these cropped images as inputs. The network computes, through a sequence of matrix multiplications and non-linear activations, probability distributions over predefined emotion categories. Server processes these distributions to obtain dominant emotion classes and intensity values. Server outputs facial emotion feature quantities as vectors associated with tracking identifiers and timestamps.

### Step 5:

Server computes body motion emotion feature quantities.

Server uses as input the preprocessed image arrays and subject locations from the behavior information records. Server applies a pose estimation algorithm to extract body joint coordinates for each subject over time. Based on these coordinates, server performs numerical operations such as computing displacement vectors, velocity profiles, and movement variance for multiple joints. Server aggregates these operations into indices representing restlessness and aggressiveness. Server outputs body motion emotion feature quantities as numeric values associated with tracking identifiers and timestamps.

### Step 6:

Server computes audio emotion feature quantities.

Server takes as input preprocessed audio arrays and their timestamps. Server segments the audio into fixed-length windows aligned with the timestamps of observed subjects. For each window, server performs signal processing operations including calculation of spectral features and cepstral coefficients. Server then applies a speech emotion recognition neural network, which computes emotion probabilities from the feature vectors. Server aligns the resulting probability vectors with the corresponding tracking identifiers based on co-occurring time and area. Server outputs audio emotion feature quantities indicating voice-based emotional states for each tracking identifier.

### Step 7:

Server generates integrated emotion information by fusing multi-modal features.

Server receives as input facial emotion feature quantities, body motion emotion feature quantities, and audio emotion feature quantities for each tracking identifier. Server combines these input vectors using a fusion algorithm, for example by weighted summation or by passing the concatenated vectors through a fully connected neural network layer. During this operation, server computes a unified emotion vector that balances contributions from facial, motion, and audio cues based on quality indicators. Server outputs emotion information records containing unified emotion vectors and associated tracking identifiers and timestamps.

### Step 8:

Server integrates behavior information and emotion information into integrated feature information.

Server takes as input the behavior information records from Step 3 and the emotion information records from Step 7. Server aligns these records by tracking identifier and time, and concatenates or structurally combines behavior feature vectors with emotion vectors. Server may perform additional normalization or dimensionality reduction on the combined data to optimize it for downstream analysis. As a result, server produces integrated feature information that represents both movement patterns and emotional states for each subject. Server outputs integrated feature information records with identifiers and time indices.

### Step 9:

Server evaluates abnormality and provisional risk level using integrated feature information.

Server uses integrated feature information records as input. Server applies an anomaly detection algorithm to the behavior feature portion, such as computing anomaly scores using a pre-trained statistical model. Server also checks predefined rule conditions on dwell time, area type, and motion indices. Server then combines anomaly scores, rule flags, and emotion vector values using arithmetic operations and decision logic to determine whether an abnormal event is present and to compute a provisional risk level. Server outputs abnormal event candidate records including a summary of integrated features, anomaly scores, detected rule violations, and provisional risk levels.

### Step 10:

Server generates a prompt sentence for risk evaluation and queries a generative AI model.

Server takes as input the abnormal event candidate records. Server performs text generation operations that transform numeric and categorical features into natural language phrases using predefined templates. Server assembles these phrases into a coherent prompt sentence including descriptions of location, dwell time, usual patterns, and emotion information. Server example output includes a prompt sentence such as:
“You are a security AI responsible for analyzing surveillance camera footage in a commercial facility. Based on the following person's behavioral history and emotional state, comprehensively evaluate the risk level of shoplifting, unauthorized entry, violent behavior, and self-harm.

### [Behavioral History]

Location: 1st floor, high-value goods area, aisle A-3
Behavior: The person has been staying in front of the same shelf for 7 minutes, frequently looking around.
Normal pattern: The average dwell time in this area is 2 minutes.

### [Emotional State]

Facial analysis: anxiety 0.8, tension 0.7, anger 0.1
Body movement: restlessness index 0.6

### [Questions]

1. Answer this person's shoplifting risk level as one of “low”, “medium”, or “high”.
2. Explain the reason in about three lines in Japanese.”

Server sends this prompt sentence as input to a generative AI model and receives as output a natural language response containing an evaluated risk level and explanation.

### Step 11:

Server interprets the output of the generative AI model and determines a final risk level.

Server uses the text response from the generative AI model as input. Server performs string processing operations, such as searching for specific keywords or structured markers, to extract the stated risk level and the accompanying explanation text. Server converts the extracted risk level into a numeric value using a predefined mapping table and compares this value with internal thresholds. Based on this comparison and the provisional risk level from Step 9, server determines a final risk level for each abnormal event candidate. Server outputs finalized abnormal event records that include the final risk level and textual explanation.

### Step 12:

Server generates evidence information and attaches additional information.

Server uses finalized abnormal event records and related monitoring target data as input. Server identifies the relevant intervals of image and audio data by matching timestamps and device identifiers. Server extracts, compresses, and packages these segments along with behavior and emotion feature vectors and the generative AI model's evaluation results into a structured evidence object. Server supplements this object with additional information fields such as time information, device identification information, and model version information. Server outputs evidence information objects ready for secure storage.

### Step 13:

Server applies encryption and stores evidence information.

Server takes evidence information objects and additional information as input. Server performs encryption operations using a selected cryptographic algorithm and cryptographic keys to transform the data into an unreadable format for unauthorized entities. Server then performs storage operations to write the encrypted data to a storage subsystem, such as a database or file system, and updates indexes to enable later retrieval by incident identifier or time range. Server outputs storage confirmation data such as a record identifier or storage success status.

### Step 14:

Server generates document information usable for legal procedures.

Server uses stored evidence information and additional information as input. Server selects key fields including occurrence time, location, behavior description, emotion state, risk level, and recommended response, and formats them into a new prompt sentence designed for report drafting. An example prompt sentence is:
“You are a security officer in a commercial facility. Based on the following data, draft a Japanese incident report about the suspicious behavior that occurred. The report must include (1) date and time of occurrence, (2) location, (3) sequence of the person's behavior, (4) analysis of the emotional state, (5) risk evaluation, and (6) recommended actions.

### [Data]

Date and time: Jan. 15, 2026, 18:32 (JST)
Location: 1st floor, high-value goods area, aisle A-3
Behavior: The person stayed in front of the same shelf for 7 minutes, frequently looking around.
Emotional state: anxiety 0.8, tension 0.7, anger 0.1
Risk evaluation: possibility of shoplifting preparation “high””

Server transmits this prompt sentence to the generative AI model and receives as output a detailed report text. Server then converts this text into document information in a predetermined electronic format.

### Step 15:

Server creates alert information and notification information for terminal devices.

Server uses finalized abnormal event records and emotion information as input. Server generates a short-form prompt sentence tailored to notification creation, describing the current situation, risk level, and desired brevity. For example, server may generate:
“You are an AI that creates notification messages for security guards in a commercial facility. Based on the following information, generate a short Japanese notification (around 100 characters) that includes (1) current situation, (2) risk level, and (3) recommended response.
[Location] 1st floor, high-value goods area, aisle A-3
[Situation] A visitor has stayed in front of the same shelf for 7 minutes and is frequently looking around.
[Emotional state] anxiety 0.8, tension 0.7
[Risk level] high (possible shoplifting preparation)”

Server sends this prompt sentence to the generative AI model and uses the resulting short notification text as output. Server encapsulates this text with incident identifier and device routing data to form notification information and transmits it to terminal devices via a messaging or push notification service.

### Step 16:

Terminal receives notification information and acquires detail information from server.

Terminal uses received notification information as input. Terminal invokes notification display functions to present the message on a display and, upon user interaction, constructs a detail request including the incident identifier and device identifier. Terminal transmits this request to server and receives as output detailed incident information. Terminal processes the received data into graphical and textual elements and updates the display to show location, risk level, emotion summary, and any associated images.

### Step 17:

User performs on-site actions and provides evaluation information.

User uses the alert and detailed information presented on terminal as input. User performs physical actions in the monitored environment, such as approaching a subject or verifying items. After responding, user operates terminal to input evaluation information including assessments of risk level appropriateness and comments. User confirms and submits this information through terminal, which outputs a feedback message transmitted to server.

### Step 18:

Server collects evaluation information and updates learning information.

Server accepts evaluation information from terminal as input. Server validates and associates each evaluation entry with corresponding abnormal event records and generated outputs. Server writes this data into a learning information repository. At scheduled times, server reads accumulated learning information and uses it as input for training or updating analysis models and prompt-sentence design rules. Server performs data selection, loss computation, and parameter update operations, and generates updated model parameters and configuration sets as output for deployment in subsequent processing cycles.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

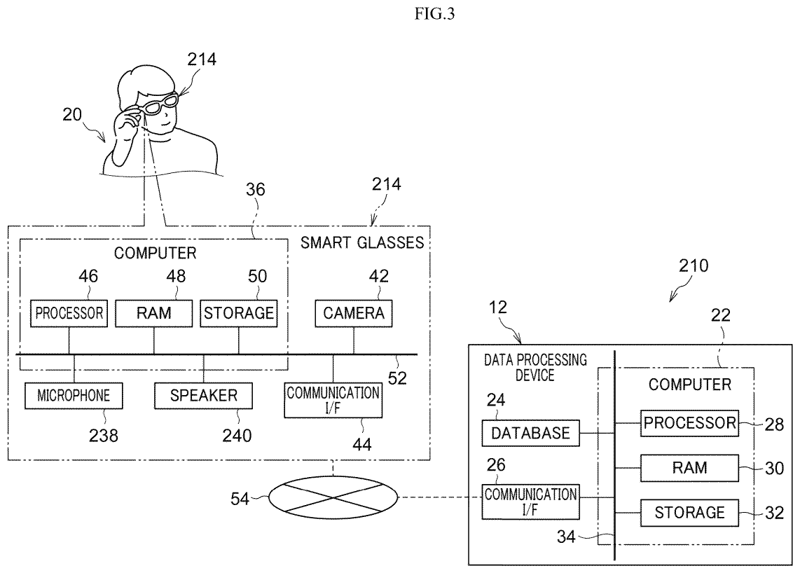

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

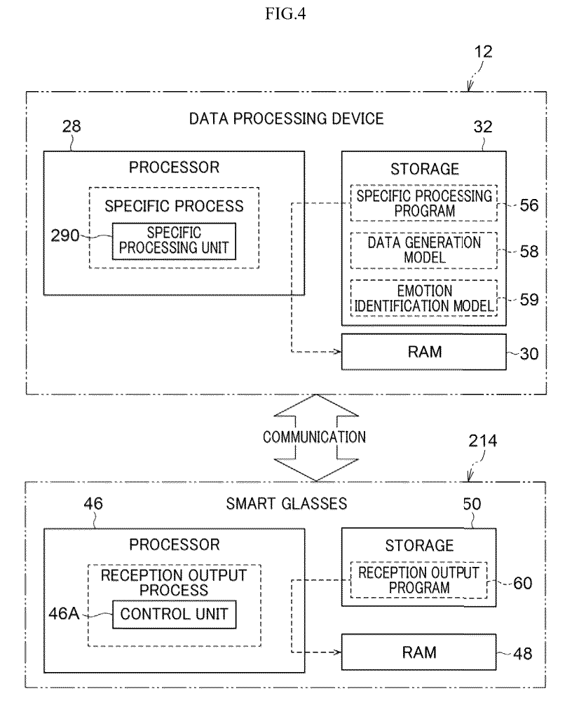

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

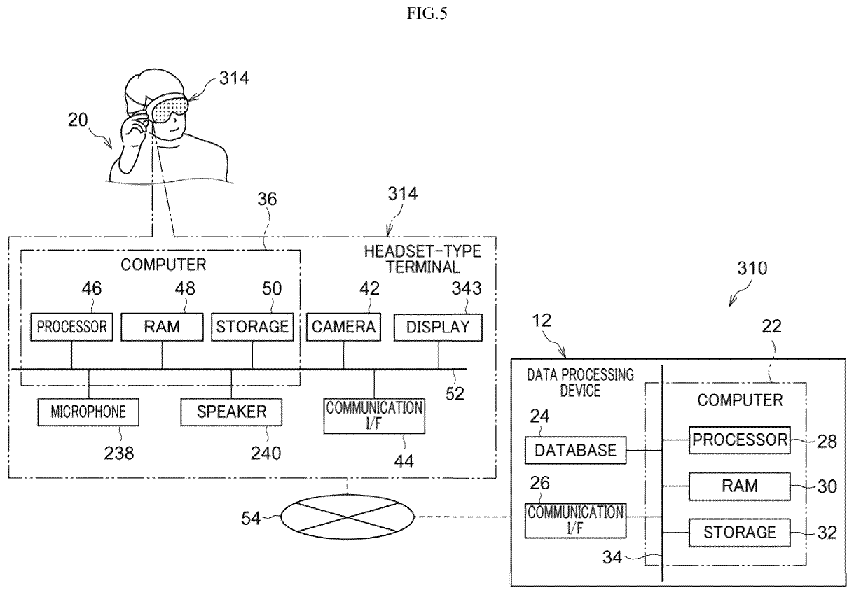

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

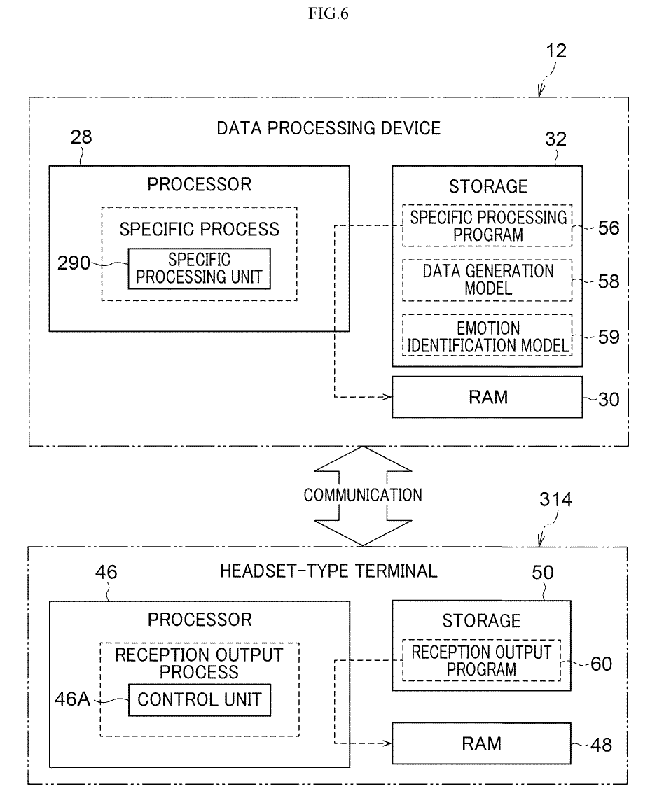

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

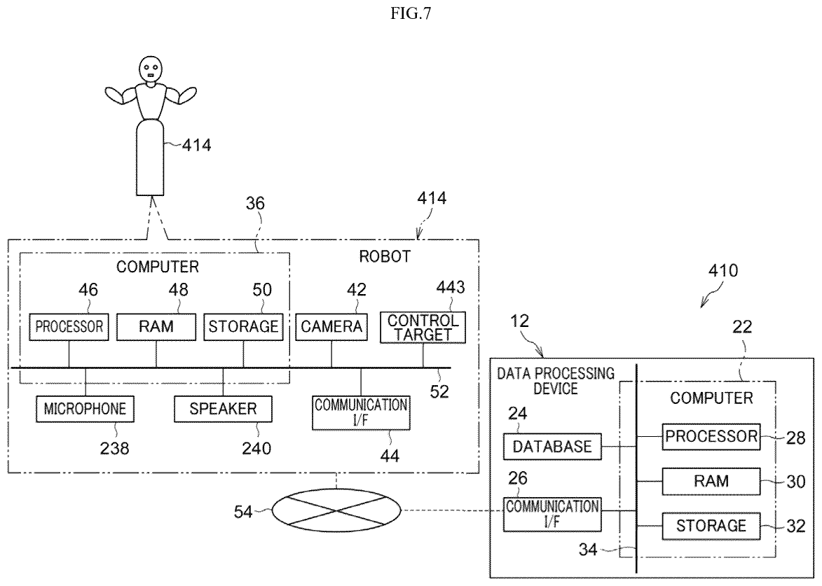

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

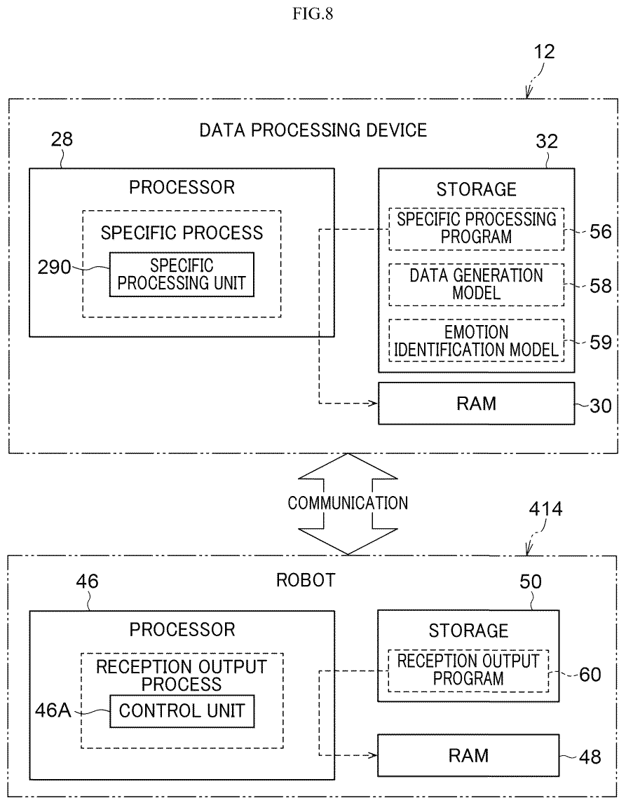

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

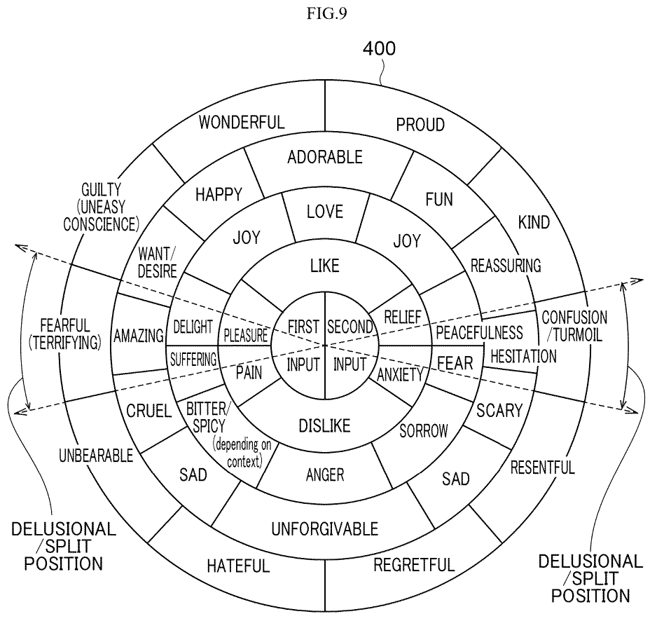

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

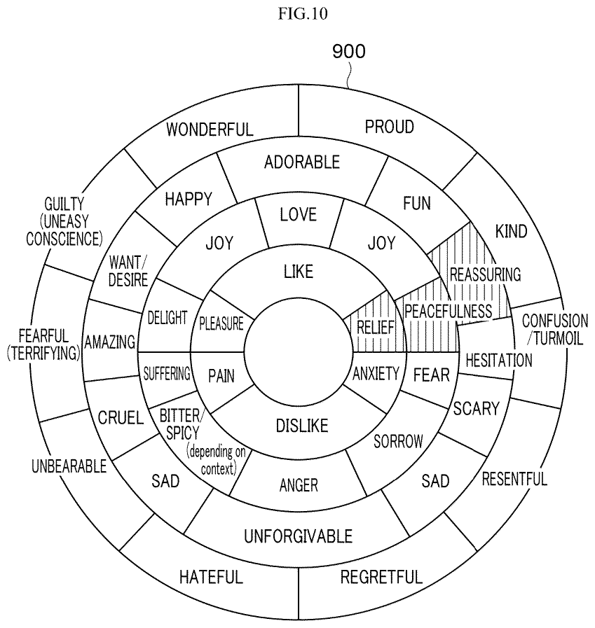

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire post information from an information providing apparatus via a communication network, normalize the post information into an internal representation including identification information, time information, medium type information, and content information, and store the internal representation in a storage area,
wherein the processor is configured to, when the content information includes character information only, supply the character information to a natural language preprocessing procedure, and when the content information includes image information or video information, execute image analysis processing and voice recognition processing to extract character information from the image information and the video information, integrate the extracted character information with the character information, and generate analysis character information, and store the analysis character information in the storage area, wherein the processor is configured to execute language analysis processing on the analysis character information, the language analysis processing including morphological analysis, lexical classification, emotion evaluation, and target entity extraction, extract post information associated with a monitoring target entity based on a result of the target entity extraction, and generate feature information for each extracted post information and store the feature information in the storage area,
wherein the processor is configured to generate a first prompt sentence in which analysis target information including the feature information and the analysis character information is described as input information, input the first prompt sentence and the analysis character information into a generative AI model, obtain determination information including whether or not the post information corresponds to harmful communication, a type of the harmful communication, a target entity, and severity, and classify and store harmful communication post information based on the determination information,
wherein the processor is configured to, for the harmful communication post information, generate evidence information including the content information of the harmful communication post information, the time information, posting subject identification information, and the determination information, add hash value information and encryption information to the evidence information, store the evidence information in the storage area in a format in which tampering is detectable, generate case information obtained by aggregating a plurality of harmful communication post information based on time range information and target entity information, and assign identification information to each case information and store the case information in the storage area,
wherein the processor is configured to generate a second prompt sentence including structured information in which the case information and the evidence information are summarized, input the second prompt sentence and the structured information into the generative AI model to cause the generative AI model to generate draft document information used for a legal procedure, arrange the draft document information in template format information to generate legal document information, and securely store the legal document information based on the encryption information,
wherein the processor is configured to generate a third prompt sentence for estimating state information indicating a psychological state of an affected subject and support policy information, based on case information associated with the affected subject, the harmful communication post information, and response information acquired from the affected subject, input the third prompt sentence and the response information into the generative AI model to obtain the state information and the support policy information, and store the state information and the support policy information in the storage area for each affected subject, and
wherein the processor is configured to generate a fourth prompt sentence that instructs content and expression style of a mental care message to the affected subject using support condition information including the state information, the support policy information, attribute information of the affected subject, and notification setting information, input the fourth prompt sentence into the generative AI model to generate the mental care message, notify the mental care message to an output apparatus, acquire evaluation information input from the output apparatus, and update the support policy information and the prompt sentences based on the evaluation information.

### (Supplementary 2)

The system according to supplementary 1,
wherein the processor is configured to generate the prompt sentences input to the generative AI model based on history information including context information of the post information, reaction information, and past determination information, generate a verification prompt sentence to which the history information is added with respect to the determination information and the state information obtained from the generative AI model, input the verification prompt sentence into the generative AI model again to verify consistency of a determination result and an estimation result, and update the harmful communication post information and the state information according to a verification result.

### (Supplementary 3)

The system according to supplementary 1,
wherein the processor is configured to aggregate contents of the mental care message, the state information, the support policy information, and the evaluation information to generate evaluation index information, automatically adjust tone information, length information, and content constraint information of the prompt sentences input to the generative AI model for generation of the mental care message based on the evaluation index information, and update instruction contents and weighting information of the prompt sentences used for detection processing of the harmful communication post information so as to execute support processing and detection processing optimized for each affected subject.

### Application Example 1

### (Supplementary 1)

A system comprising a processor,
wherein the processor is configured to
acquire observation data regarding a monitored area,
perform object detection processing and behavior analysis processing on the acquired observation data to extract abnormal event candidates based on behavior patterns of subjects,
convert attribute information and time-series information related to the extracted abnormal event candidates into natural language expressions, generate a prompt sentence including the natural language expressions, input the prompt sentence to a generative AI model, and obtain evaluation information regarding an abnormality level, an abnormality type, and a response action,
determine an abnormal event based on the evaluation information, generate evidence information including time information, location information, identification information, and related observation data associated with the abnormal event, store the evidence information in a storage unit, and generate document data for use in legal procedures,
generate warning messages and support messages for related persons based on the determined abnormal event and the evaluation information, and distribute the warning messages and the support messages to a terminal device, and
collect feedback information input from the terminal device and update the object detection processing, the behavior analysis processing, and contents of the prompt sentence based on the feedback information.

### (Supplementary 2)

The system according to supplementary 1,
wherein the processor is configured to
treat the observation data as time-series image data acquired from an information acquisition device, perform the object detection processing as image analysis processing that extracts subject regions from the time-series image data, perform the behavior analysis processing as processing that calculates staying, entering, or movement patterns in a predetermined area based on movement histories and staying times of the extracted subject regions, and generate the prompt sentence for the generative AI model so as to include a behavior description comprising the movement histories and the staying times and an instruction sentence inquiring about presence or absence of abnormality, a risk level, and a recommended response.

### (Supplementary 3)

The system according to supplementary 1,
wherein the processor is configured to
extract a partial section of the observation data corresponding to the abnormal event as evidence data, generate metadata associated with the evidence data, perform encryption processing to protect the evidence data and the document data, and input a prompt sentence including the metadata to the generative AI model to generate a report document used as the document data.

### Example 2

### (Supplementary 1)

A system comprising a processor,
wherein the processor is configured to
acquire, via a communication network, posted information from an information providing apparatus that provides an information sharing service, by using an application programming interface published by the information providing apparatus, the posted information being acquired at predetermined time intervals based on monitoring condition information including user identification information, linguistic expression information, classification label information, language type information, and region condition information that are registered in a storage apparatus, and store the acquired posted information in the storage apparatus while selecting unacquired posted information based on acquisition history information,
perform, for character information included in the posted information acquired by the acquisition, natural language processing including format normalization processing using a regular expression process and morphological analysis processing so as to generate a word sequence and a part-of-speech sequence, execute optical character recognition processing and speech recognition processing for posted information including image information or audio information so as to extract character information, generate integrated character information by combining the extracted character information with the character information included in the posted information, generate a prompt sentence including an instruction sentence for a generative artificial intelligence model by using the integrated character information as input data, input the prompt sentence and the integrated character information to the generative artificial intelligence model, and, based on evaluation information output from the generative artificial intelligence model, determine whether each piece of posted information corresponds to abusive expression against a specific target and calculate an aggressiveness index and a negative emotion index, and estimate emotional states of a transmission subject of the posted information and a target person of the abusive expression,
generate evidence information by adding attribute information including a posting time, transmission subject identification information, target person identification information, the aggressiveness index, the negative emotion index, an emotional state index of the transmission subject, and an emotional state index of the target person to posted information determined to correspond to the abusive expression, associate the posted information and the attribute information with each other in chronological order, encrypt and store the evidence information in the storage apparatus, generate a first prompt sentence requesting generation of a draft of a document for legal procedure and a second prompt sentence requesting generation of a psychological support message by using the evidence information and emotional state transition information of the target person as input data, input the first prompt sentence and the second prompt sentence to the generative artificial intelligence model, obtain a draft legal document and a psychological support message output from the generative artificial intelligence model, and output the draft legal document as document data and output the psychological support message as a message for the target person,
receive self-report information regarding a psychological state and usage behavior history information of an application from an information terminal operated by a user, the self-report information and the usage behavior history information being transmitted from the information terminal in a predetermined data format, supply the self-report information and the usage behavior history information to the generative artificial intelligence model together with a third prompt sentence so as to estimate an anxiety index, a depression index, and a stress index of the target person, classify an emotional state of the target person into a plurality of stages based on an estimation result and the usage behavior history information, store a history of the emotional state of the target person in the storage apparatus, and reflect the history of the emotional state of the target person in generation of the evidence information and generation of the psychological support message.

### (Supplementary 2)

The system according to supplementary 1,
wherein the processor is configured to
select, among a plurality of pieces of posted information acquired by the acquisition, posted information determined to correspond to the abusive expression, rearrange the selected posted information in chronological order for each transmission subject, generate time-series data including the aggressiveness index and the negative emotion index at each time point together with content of the posted information, input the time-series data to a time-series learning model so as to calculate, for each transmission subject, an anger index, a hostility index, an insult tendency index, and a continuous attack index, generate summary character information representing a set of the content of the posted information, input the summary character information to the generative artificial intelligence model together with a fourth prompt sentence requesting auxiliary evaluation of the anger index, the hostility index, and the insult tendency index, obtain auxiliary evaluation values output from the generative artificial intelligence model, integrate outputs of the time-series learning model with the auxiliary evaluation values to generate an emotional profile for each transmission subject, and provide the emotional profile to a process for generating the evidence information and the draft legal document.

### (Supplementary 3)

The system according to supplementary 1,
wherein the processor is configured to
generate a fifth prompt sentence that requests the generative artificial intelligence model to generate a draft complaint document describing, based on the evidence information and the history of the emotional state of the target person, an occurrence period of abusive behavior, representative posted examples having high maliciousness, and changes in a mental state of the target person in chronological order, supply the fifth prompt sentence to the generative artificial intelligence model to cause the generative artificial intelligence model to generate the draft complaint document, generate a sixth prompt sentence in which generation conditions including an expression tone, a character length, and presence or absence of guidance information for professional support organizations are set based on a latest emotional state of the target person and evaluation information regarding psychological support messages previously transmitted to the target person, supply the sixth prompt sentence to the generative artificial intelligence model to cause the generative artificial intelligence model to generate, as an individualized mental-care message, a psychological support message corresponding to the state of the target person, transmit the individualized mental-care message to the information terminal for display, receive evaluation information from the information terminal regarding the individualized mental-care message, and adjust generation of subsequent prompt sentences and generation logic of subsequent mental-care messages based on the evaluation information.

### Application Example 2

### (Supplementary 1)

A system comprising a processor,
wherein the processor is configured to
acquire monitoring target data from a communication infrastructure on a network,
analyze behavior information and emotion information of a subject based on the monitoring target data, determine presence or absence of an abnormal event and a risk level of the abnormal event based on the behavior information and the emotion information, generate explanation information including the behavior information and the emotion information as a natural language prompt sentence, input the prompt sentence to a generative artificial intelligence model, and classify or evaluate the abnormal event based on an output result of the generative artificial intelligence model,
generate evidence information including the monitoring target data, the behavior information, the emotion information, the risk level, and the output result of the generative artificial intelligence model when the abnormal event is determined to be present, store the evidence information in a storage device together with additional information including time information and identification information, and generate a document or report information usable for a legal procedure based on the evidence information and the additional information,
generate a prompt sentence defining contents of alert information or support information for a responder based on the risk level and the emotion information, and transmit notification information based on an output result of the generative artificial intelligence model to a terminal device, and
collect evaluation information based on a reception status of the notification information or a response result, and accumulate the evaluation information as learning information for improving estimation accuracy of the analysis and the generative artificial intelligence model.

### (Supplementary 2)

The system according to supplementary 1,
wherein the processor is configured to
calculate behavior feature quantities including position information, movement history, dwell time, and entry area of the subject from the monitoring target data, calculate emotion feature quantities including facial information, body motion information, and audio feature quantities, generate integrated feature information obtained by integrating the behavior feature quantities and the emotion feature quantities, and include the integrated feature information in the prompt sentence to be input to the generative artificial intelligence model.

### (Supplementary 3)

The system according to supplementary 1,
wherein the processor is configured to
protect and store the evidence information and the additional information by encryption processing, input a prompt sentence including the evidence information and the additional information to the generative artificial intelligence model, automatically generate document information including a history of the abnormal event, an emotion state of the subject, the risk level, and a recommended countermeasure, and output the document information as an electronic document in a predetermined format.

What is claimed is:

1. A system comprising:
circuitry configured to:
acquire, via a communication interface coupled to a packet-switched network, post data from an information providing apparatus, normalize the post data into an internal representation comprising identification data, temporal data, media type data, and content data, and store the internal representation in a memory;
extract, when the content data comprises image data or video data, character data from the image data and the video data using at least one of image analysis processing or voice recognition processing, integrate the extracted character data with character data of the content data to generate analysis character data, and store the analysis character data in the memory;
perform language analysis processing on the analysis character data, the language analysis processing comprising morphological analysis, lexical classification, emotion evaluation, and target entity extraction, and generate feature data for each post data based on the language analysis processing;
construct a first input prompt comprising the feature data and the analysis character data, transmit the first input prompt to a generative language model, and receive determination data comprising whether the post data corresponds to a predetermined classification category, a type of the classification category, a target entity, and a severity indicator;
generate, for post data determined to correspond to the predetermined classification category, evidence data comprising the content data, the temporal data, source identification data, and the determination data, compute a hash value for the evidence data, and store the evidence data in the memory in a tamper-detectable format;
construct a second input prompt comprising structured data summarizing a plurality of the evidence data, transmit the second input prompt to the generative language model, and receive generated document data; and
transmit the generated document data to a client terminal via the packet-switched network.

2. The system according to claim 1, wherein the predetermined classification category comprises harmful communication directed toward a target entity, and the determination data further comprises an aggressiveness index and a negative emotion index.

3. The system according to claim 1, wherein the circuitry is configured to acquire the post data from the information providing apparatus using an application programming interface, and to store acquisition results together with acquisition history data in the memory.

4. The system according to claim 1, wherein the circuitry is configured to perform format normalization processing on the character data of the content data using regular expressions, and to perform morphological analysis processing to segment normalized text into tokens and assign part-of-speech labels to the tokens.

5. The system according to claim 1, wherein the image analysis processing comprises optical character recognition processing, and the voice recognition processing comprises extracting an audio track from the video data and transcribing the audio track into character data.

6. The system according to claim 1, wherein the circuitry is configured to generate case data by aggregating a plurality of post data determined to correspond to the predetermined classification category based on time range data and target entity data, and to assign identification data to each case data.

7. The system according to claim 1, wherein the circuitry is configured to arrange the generated document data in template format data to generate formatted document data, and to securely store the formatted document data based on encryption processing.

8. The system according to claim 1, wherein the circuitry is configured to add encryption data to the evidence data and to store the evidence data in the memory in a format in which tampering is detectable based on the hash value and the encryption data.

9. The system according to claim 8, wherein the circuitry is configured to group the post data determined to correspond to the predetermined classification category by source identification data, order the grouped post data chronologically, compute a time-series sequence of aggressiveness indices and negative emotion indices for each source, and input the time-series sequence into a trained neural network model to compute behavioral profile data for each source.

10. The system according to claim 9, wherein the circuitry is configured to construct an additional input prompt comprising a summarized text representation of the grouped post data, transmit the additional input prompt to the generative language model, receive supplementary behavioral index data, and fuse the supplementary behavioral index data with the behavioral profile data computed by the trained neural network model.

11. The system according to claim 1, wherein the circuitry is configured to receive, from the client terminal, self-report data and usage behavior history data, and to construct a third input prompt comprising the self-report data and the usage behavior history data, transmit the third input prompt to the generative language model, and receive state estimation data comprising a plurality of psychological state indices for a user associated with the client terminal.

12. The system according to claim 11, wherein the circuitry is configured to combine the psychological state indices with numerical features derived from the usage behavior history data and to input a combined feature vector into a classifier model to determine a stage classification for the user.

13. The system according to claim 11, wherein the circuitry is configured to construct a fourth input prompt based on the state estimation data and support policy data, transmit the fourth input prompt to the generative language model, and receive a support message for transmission to the client terminal.

14. The system according to claim 13, wherein the circuitry is configured to receive evaluation data from the client terminal in response to the support message, and to update the support policy data and a prompt generation process based on the evaluation data.

15. The system according to claim 1, wherein the circuitry is configured to receive, from the client terminal, monitoring configuration data comprising user identification data, keyword data, classification label data, language type data, and region condition data, and to schedule periodic acquisition of the post data from the information providing apparatus based on the monitoring configuration data.

16. The system according to claim 15, wherein the circuitry is configured to detect a language type of the analysis character data, select a language-specific morphological analysis module corresponding to the detected language type, and perform the morphological analysis using the selected language-specific module, and to include the detected language type in the feature data transmitted in the first input prompt.

17. The system according to claim 1, wherein the circuitry is configured to receive, from the client terminal, emotion state data estimated from at least one of audio data, image data, or behavioral interaction data, and to adjust a presentation format of the generated document data transmitted to the client terminal based on the emotion state data.

18. A system comprising:
circuitry configured to:
acquire, via a communication interface coupled to a packet-switched network, post data from an information providing apparatus, and normalize the post data into an internal representation comprising identification data, temporal data, media type data, and content data;
extract character data from image data or video data of the content data using at least one of optical character recognition processing or speech recognition processing, and integrate the extracted character data with character data of the content data to generate analysis character data;
perform language analysis processing on the analysis character data comprising morphological analysis, lexical classification, emotion evaluation, and target entity extraction;
construct an input prompt comprising feature data derived from the language analysis processing and the analysis character data, transmit the input prompt to a generative language model, and receive determination data comprising a classification category and a severity indicator;
generate evidence data for post data matching a predetermined classification category, compute a hash value for the evidence data, and store the evidence data in a memory in a tamper-detectable format;
construct a document generation prompt comprising structured data summarizing a plurality of the evidence data, transmit the document generation prompt to the generative language model, and receive generated document data; and
transmit the generated document data to a client terminal via the packet-switched network.

19. The system according to claim 18, wherein the circuitry is further configured to receive self-report data and usage behavior history data from the client terminal, construct a state estimation prompt comprising the self-report data, transmit the state estimation prompt to the generative language model, receive state estimation data, and generate a support message based on the state estimation data for transmission to the client terminal.

20. A method performed by circuitry of a system, the method comprising:
acquiring, via a communication interface coupled to a packet-switched network, post data from an information providing apparatus, and normalizing the post data into an internal representation comprising identification data, temporal data, media type data, and content data;
extracting, when the content data comprises image data or video data, character data from the image data and the video data, and integrating the extracted character data with character data of the content data to generate analysis character data;
performing language analysis processing on the analysis character data comprising morphological analysis, lexical classification, emotion evaluation, and target entity extraction;
constructing a first input prompt comprising feature data and the analysis character data, transmitting the first input prompt to a generative language model, and receiving determination data comprising a classification category and a severity indicator;
generating evidence data for post data matching a predetermined classification category, computing a hash value for the evidence data, and storing the evidence data in a tamper-detectable format;
constructing a second input prompt comprising structured data summarizing a plurality of the evidence data, transmitting the second input prompt to the generative language model, and receiving generated document data; and
transmitting the generated document data to a client terminal via the packet-switched network.
